(19) United States
(12) Patent Application Publication
(10) Pub. No.: US 2007/0195787 A1
(43) Pub. Date: Aug. 23, 2007

(54) METHODS AND APPARATUS FOR PER-SESSION UPLINK/DOWNLINK FLOW SCHEDULING IN MULTIPLE ACCESS NETWORKS

(76) Inventors: Hussein M. Alnuweiri, Coquitlam, BC (CA); Yaser Pourmohammadi Fallah, Vancouver, BC (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/551,051

(22) Filed: Oct. 19, 2006

Related U.S. Application Data
(60) Provisional application No. 60/727,849, filed on Oct. 19, 2005.

(51) Int. Cl. H04L 12/56

(52) U.S. Cl. 370/395.4

(57) ABSTRACT

A method for scheduling transmission of remote and local data packets over a shared medium comprises providing a scheduler and generating virtual packets corresponding to the remote data packets. The virtual data packets are scheduled in the scheduler together with local data packets. When the scheduler indicates that a remote packet should be transmitted over the shared medium the method assigns a transmission opportunity to the remote station. The scheduler may comprise a general processor sharing (GPS)-based scheduler.

### CROSS-REFERENCE TO RELATED APPLICATION

This Application claims the benefit under 35 U.S.C. §119 of U.S. patent application No. 60/727,849, filed on 19 Oct. 2005, which is hereby incorporated herein by reference in its entirety as though fully set forth herein.

### TECHNICAL FIELD

The invention relates to data communication networks and to the control of such networks. Embodiments of the invention schedule transmission opportunities in multiple access networks. The invention has particular application in networks such as IEEE 802.11e-based Wireless Local Area Networks (WLANs) that are managed by a central controller node. The invention may be applied in providing per-session guaranteed services (Quality of Service or QoS) for multimedia or real-time applications in multiple access networks such as WLANs

### BACKGROUND

A network typically requires some mechanism for ensuring a desired level of Quality of Service (QoS) for multimedia and other real-time traffic. If the QoS provided to real-time traffic is insufficient then the performance of applications that use that real-time traffic may be unacceptable. Quality of Service is usually provided in the form of either differentiated services or guaranteed services. These services can also be provided to either a flow (belonging to one session) or an aggregate of flows (belonging to several sessions). A traffic flow (or session) is defined as a stream of data packets emanating from the same source and bound for the same destination. Data packets in a session are typically transported along the same path.

The need for providing Quality of Service (QoS) for real-time applications in wireless networks has been driving research activities and standardization efforts for some time. In particular, there have been considerable efforts in devising fair scheduling algorithms suitable for use in wireless environments. However, most of these efforts have focused on wireless networks such as 3^{3 rd} generation cellular networks. These networks usually operate in either time division duplexing (TDD) or frequency division duplexing (FDD) mode. Fair scheduling algorithms designed for such networks are usually applicable to either downlink (from base station to stations) or uplink (from stations to the base) direction, and not to both directions at the same time.

Some algorithms designed for uni-directional scheduling are WFS (Wireless Fair Server), IWFQ (Idealized Wireless Fair Queuing), and CIF-Q (Channel-condition independent fair queuing). These algorithms seek to provide fair guaranteed services. Each algorithm has different characteristics on the granularity of the fairness of the algorithm and methods for compensating for lost packets. These algorithms are designed for unidirectional scheduling (usually downlink from a base station) and assume a single fixed rate server.

In multiple-access networks that include a carrier sense multiple access (CSMA) mechanism, all stations can attempt transmission at almost any time. This means that uplink and downlink traffic may be transmitted at almost any time. In such networks the medium is shared between uplink and downlink flows. In such networks, the assumptions underlying the above-noted uni-directional scheduling algorithms are not satisfied. A further complication is that some multiple-access networks allow different operational transmission rates for each station. This means that existing scheduling algorithms designed mainly for cellular networks are not directly usable in a multiple-access networks having a shared medium.

An example of a multiple-access network is a WLAN that runs on 802.11e technology. One mode of operation of the 802.11e (or 802.11) based WLANs is the “infrastructure” mode, in which a central node manages the WLAN. The central node is called an Access Point (AP). Other nodes in the network are called stations (STA). The MAC layer of the 802.11e runs on a CSMA mechanism with Collision Avoidance (CSMA/CA). An 802.11e network normally operates in contention mode in which stations contend for accessing the channel, and sometimes collide doing so. The 802.11e protocol allows controlled-access phases, initiated by the AP, during which no contention happens and the AP decides which station can transmit a packet.

Some scheduling algorithms such as AWFS consider multi-rate operation; however, AWFS lacks the same features that are necessary for distributed CSMA/CA environments, i.e. it does not consider the shared medium nature of WLANs.

There are some specific approaches to providing QoS in 802.11 networks. Most of these approaches provide prioritized differentiated services to aggregate flows. Such approaches are mainly based on the contention access mechanisms and provide QoS in a probabilistic and aggregate manner. Very little work has been dedicated to providing per-session guarantees in WLANs, and in particular using the controlled access features offered by the 802.11e standard. The 802.11e standard itself proposes a simple algorithm (also referred to as TGe in this document), which does not necessarily provide fair service and is only effective for constant bit rate (CBR) traffic.

The methods disclosed in P. Ansel, Q. Ni, and T. Turletti, An efficient scheduling scheme for IEEE 802.11e, WiOpt'04: Modeling and Optimization in Mobile, AdHoc and Wireless Networks, 2004 (Ansel et al.) and Grilo A., Macedo M., and Nunes M, A Scheduling Algorithm for QoS Support in IEEE 802.11e Networks, IEEE Wireless Communications, pp. 36-43, June 2003(Grilo et al.) improve the TGe scheduler, but do not offer short-term fairness or guaranteed service. Ansel et al. describe extending the TGe algorithm by adjusting the transmission duration based on the collected queue size information from the stations and an estimation of its future queue size. Although this method is more efficient than the TGe algorithm, it is based on an estimation of the queue size and is only fair in the long term. Grilo et al. address the issue of inefficiency for variable bit rate (VBR) traffic. However, this method is inherently not fair and uses transmission opportunity assignments in place of packet scheduling; therefore, it is susceptible to long delays caused by simultaneous bursty transmissions on multiple flows. Flow isolation in these extensions to TGe is also poor because admission control is done based on the average rate while service assignment is burst-size dependent. Physical layer impairments such as packet loss are also not addressed by these algorithms.

There is a need for methods and apparatus for providing QoS on multiple-access networks such as networks operating under IEEE 802.11 protocols. The inventors have identified a number of characteristics that it is desirable that such methods and apparatus provide:
a mechanism for efficiently sharing the medium between uplink and downlink flows;
the 802.11e protocol provides access to the medium in a prioritized contention-based scheme that is intermittently interrupted by contention-free periods. In implementations which operate on 802.11e networks and other similar networks, the methods and apparatus should efficiently distribute contention-free and contention periods with flexibility of adjusting the duration of each access type on demand.
proportional (weighted) fairness among sessions even in cases where there is variation in the rates supported by different channels.

### SUMMARY OF THE INVENTION

This invention provides methods and apparatus for transmitting data in multiple access networks. The invention may be embodied in methods for scheduling transmission opportunities, in networking hardware, such as access points or other network controllers, for example.

One aspect of the invention provides a method for centralizing the task of scheduling transmission opportunities in a WLAN. This method allows using a conventional scheduler, with modification, in an access point (AP), to schedule access to a channel, as if all stations were located in the same node. Some embodiments of this method use the concept of virtual packets, as introduced in this disclosure, to centralize the scheduling of transmission opportunities. A virtual packet may comprise a representation of one or more packets that are present in a station in communication with an AP. Virtual packets may be generated locally in the AP using the information available from the stations with which the access point is in communication. Such information may be delivered to the AP via signaling and control messages at session setup time. Signaling messages may include a traffic specification field, describing the pattern of the uplink flow traffic (originating from the stations). The pattern of uplink traffic flow may be described, for example, in terms of the average and peak rate, the burst size, maximum and average packet sizes, and possibly the service interval. The generated virtual packets may be then scheduled along with real downlink packets in the access point. Scheduling may be accomplished by an “inner scheduler” that can use any conventional single server scheduling algorithm. At each scheduled service time, if a downlink packet is selected it may simply be transmitted, and if a virtual packet is selected the AP may generate a poll message and retrieve the actual uplink packet corresponding to the virtual packet.

Another aspect of the invention provides a method for queuing and scheduling that enables an AP to provide controlled access to flows with prior reservation, and prioritized contention access to packets that belong to flows without reservation. Some embodiments of this method rely on a queuing model comprising n+m queues, where n is the number of priority levels supported by MAC, and m is the number of flows for which traffic streams or sessions were setup and negotiated with the AP and resources have been reserved. Packets that arrive in the AP, and do not belong to a session with a reservation may be inserted into one of the n priority queues (called contention queues) depending on their indicated priority. Packets that belong to sessions with reservations may be inserted into the corresponding queue (called a controlled access queue). Virtual packets may all be inserted into controlled access queues. Downlink flows with reservations may be passed through a traffic shaper that time stamps each packet with an eligibility time for controlled access and then inserts the packets into the corresponding queues. An inner scheduler may serve all non-empty controlled access queues with eligible packets (in some embodiments, virtual packets are always eligible). When there are no eligible packets in these queues, the inner scheduler may yield control to the contention access that uses the MAC contention mechanism and serves all the contention queues, plus the controlled access queues (regardless of the eligibility of the packets).

Another aspect of the invention provides a service tracking and compensation mechanism that tracks the amount of lost controlled access service for virtual packet sessions (uplink controlled access sessions). Some embodiments of this method use a budget variable. The budget is increased by the size of a virtual packet served, and decreased by the size of the uplink packet(s) received in response to the served virtual packet. If the amount of received traffic (uplink packets) is less than the virtual packet size, the budget becomes positive, meaning that the session has not received as much service as it is entitled to. The amount of available budget can be assigned back to the station in two ways, either immediately with the next virtual packet served, or through generating a new virtual packet using the available budget and inserting it in the corresponding queue.

Further aspects of the invention and features of specific embodiments of the invention are described below.

### BRIEF DESCRIPTION OF THE DRAWINGS

In drawings which illustrate non-limiting embodiments of the invention,

FIG. 1 is a schematic block diagram illustrating key components of a prior art communication network;

FIG. 2 is a diagram illustrating the controlled and contention access durations of the 802.11(e) based CSMA/CA WLANs; and

FIG. 3 is a schematic illustration showing components of an access point and a station, according to one embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Controlled access mechanisms can be used to provide per-session fair quality of service for real-time applications in multiple access networks. Embodiments described herein provide a framework that allows for efficient scheduling of controlled- and contention-access periods while maintaining service guarantees and short-term fairness. The mechanisms may apply scheduling algorithms such as generalized processor sharing (GPS) scheduling algorithms.

The queuing/scheduling model described herein may be applied to use traffic shaping and fair scheduling to achieve efficient scheduling of HCCA and EDCA based access. Such embodiments may provide guaranteed access services for HCCA flows while sharing the remaining capacity in a contention based manner using EDCA.

IEEE 802.11 VLANs are used as examples herein but the invention can be applied to protocols other than IEEE 802.11 protocols. For example, the invention may be applied to shared medium environments such as IEEE 802.16 or multi-rate physical layers. Some embodiments provide guaranteed per-session QoS in WLANs complying with the IEEE 802.11e standard.

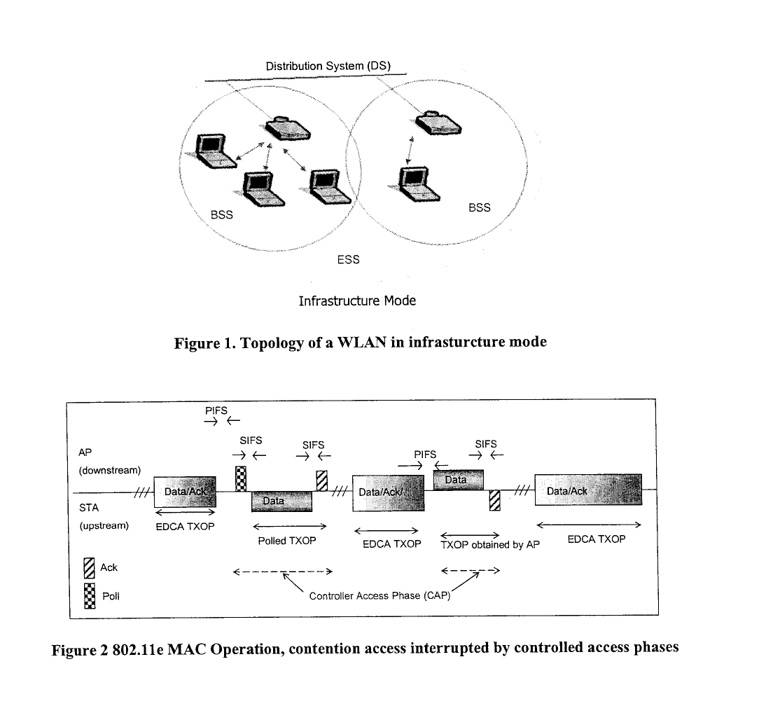

FIG. 1 shows schematically several key components of a multiple access communications network. For the purposes of example and not for limiting the scope of the invention, the network of FIG. 1 is assumed to be an 802.11e based WLAN. The illustrated network has a multiple access mechanism with the following features:
Channel access is done in a contention manner, meaning that multiple stations may attempt to access the channel at the same time;
A carrier sense mechanism is used to prevent stations from interrupting an ongoing transmission; and,
A central node (referred to herein as an access point or “AP”) exists in the network that has the ability to interrupt the normal contention mode operation and seize control of the channel. The central node can stop all other stations from transmitting autonomously for a controllable duration of time and create a controlled access phase (CAP).

During a CAP, the AP can either transmit packets downlink or send a poll to a station and receive its uplink packet. The AP specifies the CAP duration. The invention may be implemented to provide QoS on any multiple access network with the above features.

An 802.11e WLAN is used herein as a non-limiting example for the purposes of describing the present invention and not for limiting the scope thereof. The example scheduling framework has the following features:
Use of virtual packets to combine the task of scheduling uplink and downlink flows of a naturally distributed multiple access (e.g. using CSMA/CA) environment into a central scheduler that resides in an AP;
Application of a Generalized Processor Sharing (GPS) based algorithm and an integrated traffic shaper in a queuing framework to provide guaranteed fair channel access to flows with resource reservation, and sharing the remaining capacity using prioritized contention access. This scheduling framework is called Controlled Access Phase Scheduling (CAPS) herein.

One feature of CAPS is that it permits scheduling to be centralized even in an inherently distributed WLAN environment. In an 802.11 WLAN, the medium is shared between downstream and upstream (also referred to as downlink and uplink in this document) traffic at all times. Thus, any scheduling framework must handle packet transmissions from individual stations to the AP (i.e. upstream), and from AP to the stations (i.e. downstream). Downstream packets are available in the AP buffers and can be directly scheduled, while upstream packets reside in the stations generating these packets and cannot be scheduled directly. In the embodiment described herein, the AP uses upstream traffic specifications, available through signalling or feedback, and schedules poll messages that allow for upstream packet transmission.

In this embodiment, packets from remote stations (i.e. the upstream packets) are represented by “virtual packets” in the AP. The AP then uses a single server scheduler (e.g. any conventional scheduler such as weighted fair queuing, WFQ) to schedule both the virtual packets and real packets (e.g. downstream packets that are under the direct control of the AP). When scheduling virtual packets, the AP issues poll messages in the appropriate sequence to generate transmission opportunities for the corresponding upstream packets. This mechanism may be called “hybrid scheduling” because it combines upstream and downstream scheduling in one scheme. The performance of the scheduler will depend on the specific algorithm applied to perform scheduling. The framework can use any suitable single server scheduler with some modifications. GPS based fair algorithms are good candidates for the scheduling algorithm. Such algorithms include: Start-time Fair Queuing (SFQ), Weighted Fair Queuing (WFQ), or Worst case Fair Weighted Fair Queuing (WF²Q). For brevity we name these CAPS options as CAPS-SFQ, CAPS-WFQ and CAPS-WF²Q. Using a GPS based algorithm can ensure fairness and bounded delay (thus controlled jitter) and can increase the capacity of the network for supporting multimedia sessions.

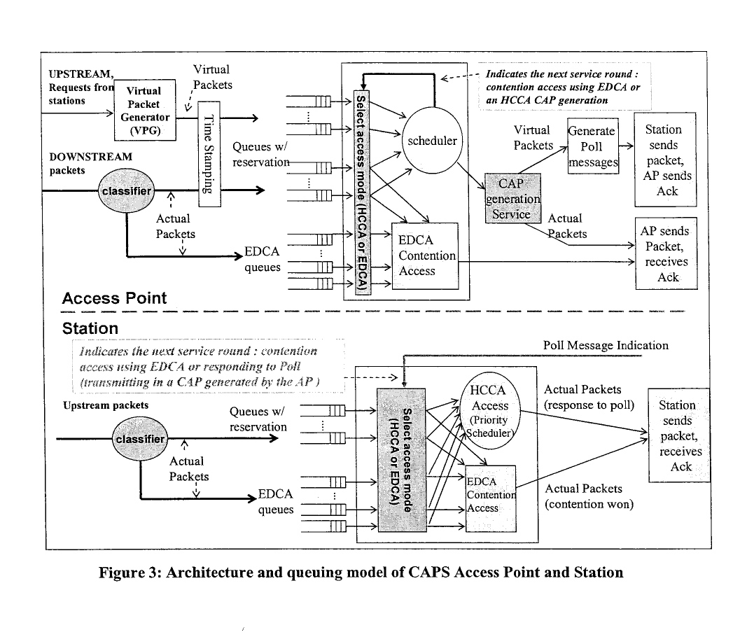

The task of generating virtual packets is performed by a module called Virtual Packet Generator (VPG), as depicted in FIG. 3. VPG uses control plane requests (for example, explicit messages delivered through ADDTS messages of 802.11e MAC or implicitly through interpreting Session Initiation Protocol, SIP, calls in higher layers), or traffic pattern estimation to determine the patterns of virtual packets (or flows) that must be generated. For example, for a voice call, a periodic flow of packets similar to the real traffic is generated by the VPG. For video sessions, a stream of packets resembling the IP . . . P pattern of a video is generated. The generated virtual packets are classified along with actual downstream packets and are queued and scheduled for service based on the scheduling algorithm as described below.

Packets that are served by the scheduler are treated differently based on whether they are actual or virtual packets. Actual packets are directly transmitted in a downstream CAP. For virtual packets an upstream CAP is generated by sending a poll message and assigning the appropriate transmission opportunity (TXOP) to the station whose virtual packet is being served.

Scheduling and Traffic Shaping

Using the hybrid scheduling model enabled by virtual packets, facilitates use of a centralized queuing and scheduling model in the AP, as depicted in FIG. 3. The queuing/scheduling model, depicted in FIG. 3, combines controlled- and contention-access operation to achieve both fairness and service guarantees. In all stations (including the AP), the queuing model comprises all queues created for flows with reservation (controlled access queues) plus the contention access queues for all priority levels.

After each transmission or channel busy period, the scheduler examines the queues with reservation (virtual and actual flow queues) and determines whether a queue must be served. In this step only queues whose traffic conforms to the declared traffic shape are examined. If a queue is found eligible for controlled access service and is selected by the scheduler, it is given controlled access through a CAP generation. If no queue is found, the scheduler selects the contention access mode and allows all actual packet queues in the system, including those with non-conforming traffic, to contend for accessing the channel using prioritized contention rules (EDCA rules in case of 802.11e).

When contention is allowed, all queues in the stations will contend to access the channel (including the controlled access queues). In some embodiments, in the AP only contention queues plus the downlink controlled access queues are allowed to contend. Virtual flows are excluded from contention because their corresponding actual flows in the stations are already involved in contention. The contention parameters used by contending controlled access queues are chosen locally based on the information collected during session setup.

The operation of CAPS can be divided into three tasks. The first task is admission control and generating virtual packets according to the declared session information. The second task includes time-stamping, pre-shaping and queuing the arriving packets. The third task is selecting the packet to be served and controlling the switching between controlled and contention access (HCCA and EDCA in case of 802.11e).

Task 1: Generating Virtual Packets & Admission Control

This task processes requests from stations to set up flows for sessions. Admission control rules are applied to determine whether a session can be admitted by the AP. Any suitable admission control mechanism that works with fair scheduling algorithms can be used. Those skilled in the field are aware of various admission control mechanisms. For an admitted uplink session, this process generates virtual packets using the available information. If service interval Sᵢ and average packet size Pᵢ are specified, virtual flows of size Pᵢ bits are generated every Si seconds. If Sᵢ is not declared, we can use the declared average rate rᵢ, and generate virtual packets of size Pi every (rᵢ/Pᵢ) seconds. Note that this process provides bandwidth guarantees to flows specified by their average rate requirements.

To provide delay guarantees in the system, the maximum burst (bᵢ) size of each flow i must be supplied to the traffic shaper. Limiting the burst size is required to provide delay guarantees in GPS-based schedulers such as weighted-fair queuing and its variants.

One way of increasing the system capacity is to allow bursty transmission through TXOPs and reduce the overhead incurred by poll messages. This can be achieved in CAPS by using larger virtual packets with proportionally longer service intervals (to keep the average rate constant).

For applications such as Voice-over-IP where periods of silence and activity exist, a consistent stream of polls to silent stations would be wasteful. To address this issue the VPG may be configured to stop sending polls after detecting an empty queue (through the queue size field of the received poll response being set to zero or the more_data bit turned off). The VPG will resume generating VPs as soon as it receives a new frame for the session that arrives through contention access. If contention access may cause unacceptable delay the VPG can send polls at a lower rate to inquire about the activity of the voice source.

Task 2: Oueuing Packets

Packets that are received by the CAPS scheduler are classified into three groups:

1) virtual packets for uplink flows with reservations;

2) real packets belonging to downlink flows with reservations;

3) packets with no flow-association and no reservation.

The first two types may be called controlled access packets (or HCCA packets in 802.11e) and are assigned to controlled access queues. For scheduling purposes the length attribute of these packets may be adjusted to account for the different overheads incurred by each type. For example, virtual packets require an extra poll message at the beginning of a CAP, so the transmission period for such packets may be increased accordingly.

When a packet without reservation is received, its access category field is examined and the packet is stored in a corresponding contention access queue. For controlled access packets, the Traffic Stream ID of the (virtual or real) packet is used to determine its corresponding session queue. Such a field exists in most QoS enabled frame formats. Before queuing, the conformance of the arriving controlled access packet to its flow's declared traffic pattern is checked and the packet is properly tagged with an eligibility time indicating when the packet is eligible for controlled access service. The packets are then time-stamped with start or finish tags according to the algorithm used in the inner scheduler (e.g. SFQ, WFQ or WF²Q). The packet start and finish times for these inner schedulers (SFQ, WFQ, and WF²Q) are given by:

$$\begin{matrix}{S}_{i}^{k} = max ( {F}_{i}^{k - 1} , V ( t ) ) & ( 1 ) \\ {F}_{i}^{k} = \frac{{L}_{i}^{k}}{{r}_{i}} + {S}_{i}^{k} & ( 2 )\end{matrix}$$

Where Sᵢ^{k} and Fᵢ^{k} are the start and finish timestamps for the k^{th} packet from the i^{th} flow, Lᵢ^{k} is the adjusted packet length, rᵢ is the rate assigned to the flow, and V(t) is the virtual time function.

The virtual time is calculated differently for each inner scheduler. For WFQ and WF²Q, V(t) represents the progress time of a GPS scheduler that is fed with the packets from these queues and is calculated as:

$$V ( {t}_{j} - 1 + T ) = V ( {t}_{j} - 1 ) + \frac{T}{{\sum }_{i ∈ {B}_{j}} ( {r}_{i} / C )} , \\ T \leq {t}_{j} - {t}_{j - 1} , j = 2 , 3 , … \qquad ( 3 )$$

where C is the server rate, T is the time between two subsequent events j and j−1 (i.e. packet arrival or departure) in the GPS system and Bⱼ is the set of backlogged sessions (queues) between these events. For SFQ the virtual time is described in a much simpler way as the start tag of the packet in service at time t. At the end of a busy period v(t) is set to zero (or the last packet's finish time).
Task 3: Scheduling and Traffic Shaping

With packets queued in either controlled access or contention queues, a task of CAPS is to determine which mode of operation should be used and which queue must be served at each service time. A service time occurs after a transmission is completed and the AP gains access to the channel according to the MAC rule. For 802.11 networks, AP senses that the wireless medium has been idle for one PIFS duration. At this time the algorithm described below indicates whether a CAP for a virtual or actual packet must be generated, or control should be given to contention access:

```
Step1: /* Select the queue to serve: */
{
  /* Find queue i with smallest HoL (“Head-of-Line”) time stamp, from the
set of all virtual flow queues plus all downlink HCCA queues with eligible
HoL packets.*/
  A1:
    i = find_queue_to_serve( )
  /* budget update for Virtual Flows*/
  if ( i Virtual Packet queue)
      gᵢ = min { bᵢ, gᵢ + vp_size }
      goto Step2;
  else if ( i downlink HCCA queue)
      goto Step2; /* actual downlink packet
            to be served*/
  goto Step2; /* no packet to be served */
} /*end of Step 1*/
```

```
      Step2: /* Determine and apply EDCA or HCCA operation*/
{
  If (no queue selected in Step1) /* yield to EDCA*/
  exit; /*exit the algorithm till next service round */
else /*initiate a CAP, HCCA operation*/
{ If (i: Virtual Packet queue)
    send a poll to queue i's destination;
  else if (i: actual packet queue)
    send the packet in a CAP;
}
WAIT for response or timeout;
If (data of size L received in response
    to poll from queue i )
  gᵢ = gᵢ − L
else (timeout or failure)
  do not update gᵢ;
}
WAIT until next service round; goto Step1;
```

The above algorithm, explained in a two-step pseudo code format, requires maintaining a queue budget parameter gᵢ for uplink traffic control. The queue budget parameter keeps track of the lost service time and the available TXOP time for a specific virtual flow at any given service time. Initially, gᵢ is set to zero; it increases with each transmitted poll, and decreases with each response received.

The algorithm assumes that generated virtual flows conform to the reservations made during session setup, but actual downlink or uplink flows may not conform to their previously declared pattern. Therefore, traffic shaping and control is performed differently for actual and virtual flows. For uplink flows one can obtain an estimate of the flow pattern through virtual flow specifications and apply traffic shaping when the actual packets arrive. This can be achieved through compensation as explained below.

For actual downlink flows, one can apply traffic shaping measures directly to the flows. This may be done, for example, by applying an eligibility flag as explained below. The scheduler only serves virtual flows with packets and actual flows with eligible HoL (Head-of-Line) packets. When no such packets are found, control is given to contention access mode. Therefore the decision for switching to contention mode is made indirectly through traffic shaping and virtual packet generation processes.

Traffic Shaper

The integrated traffic shaper in the system is provided for downlink actual packets. Virtual packets already conform to a predefined shape (enforced by the VPG). The integrated traffic shaper ensures that actual downlink flows do not exceed their promised controlled access service. This ensures that CAPS only assigns the promised service times to controlled access and switches to contention mode for using the remaining capacity.

A time stamp called eligibility_time may be associated with each queued packet for use in traffic shaping on downlink controlled access flows. Eligibility time may be derived based on a token bucket shaper with envelope (rit+bᵢ). Upon arrival, each packet is tagged with the time when it becomes eligible (compared to system time). The inner scheduler only looks at HoL packets whose eligibility time is past the system time. However, for EDCA all HoL packets can contend.

For CAPS-WFQ and CAPS-WF²Q one can implement the shaper in a separate queue or in the same queue. Where a separate queue is used for traffic shaping, the packets in controlled access queues will all be eligible for scheduling. However when contention mode is active, the shaping queues are also used for contention if their corresponding controlled access queues are empty.

Where the traffic shaper uses the same queue as the scheduler, the eligibility_time tag may be used to identify HoL packets eligible for controlled access scheduling. Contention access is applicable to all HoL downlink packets in this case. Where the traffic shaper uses the same queue as the scheduler, passing the packet arrival event to the GPS emulator for ineligible packets may be delayed until the packets reach their eligibility times. Time stamping packets only happens after a packet becomes eligible too. For virtual time calculation the GPS emulator only uses the packet arrival event as an external trigger.

For CAPS-SFQ the shaping can be done in a much simpler way because virtual time is calculated using SFQ events. The scheduling tasks, including the time stamping and update of the virtual time, only apply to packets with eligibility time reached. Thus in each service round the scheduler only acts on HoL packets that are eligible. If no such packet is found the scheduler yields to contention access mode and takes over after the contention operation completes (or PIFS passes). SFQ is in general much easier to implement than WFQ and WF²Q; the fact that the shaping for CAPS-SFQ is also very simple provides an advantage of CAPS-SFQ over other CAPS options.

Lost Service Compensation for Uplink Flows

Traffic shaping for uplink flows is mainly done through generating conforming virtual flows. However, in some cases the length of an uplink packet, sent in response to a poll, may be smaller than that of the virtual packet that generated the poll. In this case the budget gᵢ does not go to zero after receiving the poll response and increases (up to the burst size) by the unused amount of budget. The positive and increased budget for virtual flows is an indication of lost service for uplink flows. This lost service can be compensated by:

1) “Immediate Compensation” in which the entire budget is assigned in one polled-TXOP when the next virtual packet for this queue is served, or

2) “Deferred Compensation” in which the TXOP is always assigned based on the length of the virtual packet currently in service and any excess budget is used to generate additional virtual packets for the same virtual flow. Compensation occurs for the flow when these packets are later served.

Immediate compensation is simpler to implement, while Deferred compensation yields lower delay bounds for the scheduler.

With immediate compensation a small virtual packet may result in a large TXOP being assigned to the station to compensate for the lost service. We call this case Long Response (or LR). The LR case may result in a large (but still bounded) difference between CAPS operation and the ideal GPS for a short period of time.

With deferred compensation, since the TXOP assigned to a station as a result of serving a virtual packet is not derived from the budget parameter but from the virtual packet size, we ensure that the long response case does not happen and the subsequent service disturbance is avoided for other flows, as a result the service guarantees for other flows are still valid.

For deferred compensation, a virtual flow that has a positive gᵢ can exchange the accumulated budget with additional virtual packets that are then stored in its queue and will get service at the guaranteed rate. The compensation virtual packet is generated when an indication of non-zero queue size is received (in case of 802.11e this is received either through HCCA or EDCA packets from the station). Deferred Compensation is, in effect, similar to retransmitting a virtual packet (poll message) and re-assigning the TXOP until it is properly responded to. This mechanism isolates the compensation for a specific flow from the rest of the flows and enhances service guarantees. It, however, introduces implementation overhead. This option may be a good choice when there is not a good estimation of uplink flows and the bounds on service discrepancy become unacceptably large.

The budget grows if there is not enough data in the station, meaning that at the end of the response TXOP the station queue is empty, so the extra budget should not be re-assigned through generating a virtual packet immediately, and the scheduler must wait until it receives a message from the station with non-zero queue size report. It then creates a virtual packet with the same length (up to the available budget) and stores it at the end of the queue.

Adaptations for Wireless Channels

Physical channel impairments in a WLAN result in packet loss and consequently retransmission of packets by the MAC layer. If the quality is consistently low, the operational transmission rate for a station may be reduced as well. Channel impairment issues can be dealt with in many ways.

One method is to use a lead/lag model as described in earlier works on single direction schedulers. These models rely on detecting channel quality beforehand and lending one stations transmission time to another to avoid transmitting in a bad channel. A lead/lag counter is maintained and the stations that are leading in their service will gradually give back service to the lagging stations. Such methods are not usually applicable if good channel estimations are not available. They also cannot be applied effectively when uplink flows are concerned since the AP may not know the conditions affecting various stations. If channel monitoring is efficiently possible in a WLAN, the lead/lag method may be used.

Another option is to rely on the retransmission feature of the MAC and adapt a simpler model of readjustment of scheduling task in order to maintain fairness. To deal with packet loss, the MAC layer can retransmit a packet a few times until it arrives at the receiver or is dropped after n attempts (n must be small enough to avoid causing excessive delay for the entire session). If retransmission happens during a CAP it may disturb the fairness of the scheduler since a station may take longer than expected to transmit the packet. To counter this problem there are several options.

One option is to avoid immediate retransmission and wait until the next service round for this queue. This is automatically achieved for virtual packets by the deferred compensation method discussed above. For downlink packets the HoL packet's time stamps are recalculated as if it was a new packet. This method prevents problems in this flow from disturbing other flows and ensures that service guarantees are still valid. Also, a good side effect is that immediate retransmission on the bad channel is avoided and situation may improve before the next service round.

Since the retransmitted packet will remain eligible for controlled access service, the retransmissions are indeed done at the expense of contention access traffic or in other words using the spare capacity of the channel. It is the responsibility of the admission control mechanism to reserve a portion of the channel capacity for dealing with packet retransmission.

Another option to maintain fairness in presence of retransmission is to move the packet that incurred problem to a special queue set up for retransmission (or to a contention queue) with separate reservations. This method is similar to Server Based Fair Algorithm (SBFA). This, in effect, isolates the effect of packet loss and retransmission from all other queues, and from the next packets in the same queue.

The re-adjustment of packet time stamps, as described above, must be reflected in virtual time calculation of the inner scheduler as well. Implementing this policy for CAPS-SFQ is very simple as its virtual time is calculated using real events from the scheduler; however for CAPS-WFQ and CAPS-WF²Q, applying the length adjustments to virtual time, though feasible, is computationally expensive because virtual time is calculated from simulating a GPS server.

In some embodiments, integrity and fairness of the GPS based inner scheduler may be maintained when a compensation mechanism is used, a WLAN operates in a multirate environment, or when packet loss happens by adjusting the time stamp of the enqueued packets so as to ensure that the order of time stamps for the remaining packets in the system leads to each queue receiving a fair share of the channel, as originally provided by the inner scheduler. When a SFQ inner scheduler is used, it is enough to adjust the time stamps of only the head of line packet of the queue that has just been serviced. This adjustment may be done by recalculating the start and finish time stamps of the next packet in queue, taking into account the rate at which the served packet was transmitted and whether service time or throughput fairness is to be acheived, the actual length of the response packet if the served packet was a virtual packet, and/or whether the packet transmission failed and the packet is re-inserted in the head of line. These calculations follow the original inner scheduler's rules, but the parameters are supplied as stated above. When other types of inner scheduler, such as WFQ, are used, the above adjustments are applied to all queues, not just the served queue, and to all packets in those queues.

The apparatus and methods described herein may be implemented, for example, in WiFi access points. For example, the apparatus and methods may be applied in:
Enterprise voice or video applications such as Voice over IP over WiFi, or WLAN telephony systems.
Home or neighbourhood video or audio broadcast applications using WiFi. For example home multimedia devices such as televisions, stereos, loudspeakers and the like may exchange low-jitter streams of video or audio by way of a WLAN incorporating apparatus and methods as described herein.
Multimedia applications such as voice and video conferencing and streaming in WiFi environments in which there is also background data traffic.
Traffic control for WiFi ISPs or HotSpots. It is possible to set aside part of the traffic for each client using CAPS, and guarantee a certain bit rate for specific clients, while allowing the remaining capacity to be used by other stations. This feature is in particular appealing to WiFi service providers in environments that they want to have control over the use of bandwidth.

The following is a paper which describes exemplary embodiments of the invention, some features of which may not be required in all embodiments of the invention:

1. Introduction

Supporting real-time multimedia applications such as voice-over-IP, video telephony and TV over Wireless Local Area Networks (WLAN) requires realizing guaranteed services that are not currently provided by existing WLAN technologies such as IEEE 802.11. To address this issue, the IEEE has approved a new standard, IEEE 802.11e [2], to enhance the original MAC layer of the 802.11 standard with features that facilitate guaranteed and differentiated service provisioning. However, the standard only specifies the features required for the new service provisioning and leaves the design of specific scheduling disciplines that utilize these features to the developers and equipment vendors. The solution proposed in this paper fills this gap by showing how to utilize the available features to provide guaranteed services for real-time multimedia applications. We target the infrastructure mode of operation in which a central access point (AP) controls the network. Most commercial and residential WLANs use this mode. The need for providing Quality of Service (QoS) for real-time applications in wireless networks has been driving research activities and standardization efforts for some time. In particular, there have been considerable efforts in devising fair scheduling algorithms for wireless environments [3]. These efforts were mostly concentrated on scheduling in cellular networks or generic wireless environments. For example, some notable algorithms such as WFS (Wireless Fair Service) [4], IWFQ (Idealized Wireless Fair Queuing) and its variation Wireless Packet Service (WPS)[5] and CIF-Q (Channel-Condition Independent Fair Queuing) [6] address the scheduling issue in a general wireless network. These algorithms are further enhanced by other QoS measures such as the mechanism proposed in [7], which targets hybrid TDMA/CDMA cellular networks. The scheduling issues in broadcast communication environments, combined with peer to peer communications, have also been presented in recent works [8]. Although the above works provide QoS solutions in other wireless networks, the specific QoS issues in CSMA/CA WLANs are not addressed by these mechanisms.

IWFQ and WPS present coarse short-term fairness and throughput bounds. CIF-Q and WFS achieve short-term and long-term fairness, short-term and long-term throughput bounds, and tight delay bounds for channel access. However, these algorithms are designed for a single direction scheduling (essentially on the downlink from the access point) and are based on the assumption of a single fixed rate server. These assumptions are not applicable to a CSMA/CA network such as IEEE 802.11. A WLAN based on 802.11 shares the medium at all times between uplink and downlink flows and is inherently a distributed environment, it also allows different operational transmission rates for each station. This means that these existing algorithms that were mainly for cellular networks are not directly usable in an 802.11e (or 802.11) network. The multi-rate operation is considered in other notable algorithms, such as AWFS [9][10]; but these algorithms also lack the same features that are necessary for a distributed CSMA/CA environment and do not consider the shared medium nature of WLANs.

There also exists another set of QoS solutions specially designed for 802.11 networks. Some of these algorithms, such as the ones proposed in [11], [15], and [16] provide prioritized differentiated services to aggregated flows. These solutions are mainly based on the contention access mechanisms and provide QoS in a probabilistic manner to traffic aggregates. In fact, research on providing per-session guarantees in WLANs, especially using the new controlled access features of the 802.11e standard, has been very limited.

The 802.11e standard itself proposes a simple algorithm (referred to as TGe in this article), which does not necessarily provide fair service and is only effective for strict constant bit rate (CBR) traffic. The methods in [13] [14] improve the proposed TGe scheduler, but do not offer short-term fairness or guaranteed service. The method in [13] extends the original algorithm by adjusting the transmission duration based on the collected queue size information from the stations and an estimation of its future queue size. Although this method is more efficient than the TGe algorithm, it is based on an estimation of the queue size and is only fair in the long term. The proposed extension to TGe in [14] addresses the issue of inefficiency for variable bit rate (VBR) traffic. However, this method is inherently not fair and, as in [13], uses transmission opportunity assignments in place of packet scheduling; therefore, it is susceptible to long delays caused by simultaneous bursty transmissions on multiple flows. Flow isolation is also poor in [13] and [14] due to the fact that admission control is done based on the average rate while service assignment is burst-size dependent. Physical layer impairments such as packet loss are also not addressed by these algorithms.

Our solution focuses on using controlled access mechanisms to provide per session fair quality of service for real-time applications. We present a framework that allows for efficient scheduling of controlled and contention access periods while maintaining service guarantee and short term fairness through employing Generalized Processor Sharing (GPS) based scheduling. We demonstrate that it is possible to provide guaranteed per-session QoS without need to depart from the IEEE 802.11e standard specifications as is the case with most other solutions. We identified three characteristics of an 802.11e WLAN that need to be taken into account when devising such a QoS solution:
First, the solution must provide a way of efficiently sharing the medium between uplink and downlink flows; meaning that the solution should provide a unified scheduling scheme for the combined traffic flows from both directions.
Second, the 802.11e describes access to the medium in a prioritized contention based scheme that is intermittently interrupted by contention free periods. The scheduler must efficiently distribute contention free and contention periods with flexibility of adjusting the duration of each access type on demand.
Third, the scheduler must achieve proportional (weighted) fairness among sessions and be able to handle the effects of wireless channel variation.

We have developed a scheduling solution that addresses all these issues. To the best of our knowledge this is the first design that addresses all the above issues in a single framework for IEEE 802.11e networks.

In this article, we first provide a short description of the 802.11e standard, highlighting its controlled access mechanism. We then present a new access scheduling framework designed for the 802.11e MAC, and capable of providing per-session QoS guarantees for such applications as interactive voice and video over WLAN. Essentially, the proposed solution provides guaranteed services to flows that make reservation with the WLAN Access Point (AP) by means of the available MAC signalling methods, while at the same time, allowing the normal contention based access to take place using the remaining capacity of the channel. This approach is different from the existing polling mechanisms in which long alternating contention free and contention periods are generated (e.g., [19]), resulting in uncontrolled delay bounds and inefficient operation. Our design approach is called Controlled Access Phase Scheduling (CAPS). The CAPS algorithm is based on a number of novel concepts such as Virtual Packet generation and combined scheduling of uplink and downlink flows [17], as well as using the well established Generalized Processor Sharing (GPS) based scheduling discipline in a new unified queuing framework for both contention and controlled access mechanisms.

1.1 IEEE 802.11e MAC Specifications

The IEEE 802.11e standard introduces new features that enhance the MAC layer of the original 802.11 standard in order to provide QoS to real-time multimedia applications [2]. The offered QoS can be categorized into two classes of prioritized contention access and guaranteed contention free access. Both schemes are built on top of an enhanced version of the Distributed Coordination Function (DCF) which is the main function of the 802.11 MAC. In general, access to the medium is done in a prioritized contention manner during each Contention Period (CP). The original MAC allowed the AP to initiate Contention Free Periods (CFP) on a periodic basis. The 802.11e MAC redefines CFP as a Controlled Access Phase (CAP) and allows initiating mini CFPs or CAPs arbitrarily even during the contention period.

The basis for the 802.11 MAC is a CSMA/CA mechanism (Carrier Sense Multiple Access with Collision Avoidance). This mechanism is essentially a contention access method that uses a binary backoff procedure for collision resolution and inter-frame space (IFS) time intervals for prioritizing access to the medium. The rules describing the timing relations in the MAC are described by DCF. Stations that have frames to send are only allowed to transmit if they find the channel idle for a frame-specific IFS duration (FIG. 1). For data frames in contention mode, this waiting time is extended by a random backoff interval as well. If priorities are specified, as in 802.11e, the contention window from which the random backoff number is selected, and the IFS waiting times may be different for each priority level.

The IFS gap for data and RTS frames is AIFS (Arbitration IFS), while beacons and initial CAP messages (poll or data) use a shorter gap time, PIFS, that gives them a higher priority in accessing the channel. Acknowledgements (Ack), packet fragments, responses to polls and CTS messages use a SIFS gap which is the shortest IFS, giving them the highest access priority. SIFS is only used when contention has already been won, or during a contention free period; therefore, it provides an uninterrupted control of the channel for as long as frames are sent with SIFS gaps. Poll and data frames that are sent using PIFS (to start a CAP or CFP) are also able to grab the channel unchallenged if they follow a completed frame exchange sequence; this is because after a frame exchange cycle finishes, all stations have to use AIFS plus backoff interval before they can access the channel while AP can send after PIFS, in effect giving it absolute priority over others. However, if the medium was free for a long time after a busy period, the PIFS waiting for AP and the AIFS plus backoff for stations might coincide, resulting in collision, or a data frame might grab the channel sooner. In any case, the AP can recover quickly by grabbing the channel after PIFS waiting following the busy or collision situation. This is because it does not have to do a backoff before starting a CAP or CFP and only needs to wait a PIFS, thus having guaranteed contention free access [2].

[image]

The 802.11e standard also introduces an important new concept: Transmission Opportunity (TXOP). A transmission opportunity specifies the duration of time in which a station can hold the medium uninterrupted and perform multiple frame exchange sequences consequently with SIFS spacing. A station can obtain a TXOP either through contention or be granted a TXOP by the AP. After completion of each frame exchange cycle during a TXOP, if enough time is left in the station's TXOP, it can retain control of the medium and commence a new frame exchange cycle after a SIFS period, otherwise it does not continue transmission using SIFS and enters the normal contention mode using AIFS deferred access and normal backoff.

MAC layer rules for controlling and coordinating access to the wireless medium in the 802.11e standard are specified under the Hybrid Coordination Function (HCF) protocol. HCF offers two access mechanisms; EDCA (Enhanced Distributed Channel Access) which is an enhanced version of DCF and is used for contention based access, and HCCA (HCF Controlled Channel Access) that replaces the Point Coordination Function (PCF) of the 802.11 standard and specifies the polling or controlled access schemes. The 802.11e standard defines 8 different traffic priorities in 4 access categories and also enables the use of traffic stream IDs (TSIDs), which allow per flow resource reservation.

Under EDCA access mechanism, depending on the type of a frame (Data or Control) and its priority, different AIFS values are used (Arbitration IFS or AIFS in FIG. 1). The backoff windows are also different for each priority. Shorter AIFS times and smaller contention windows give higher access priority. This prioritization enables a relative and per-class (or aggregate) QoS in the MAC. The 802.11e standard allows for dynamically adjusting most EDCA parameters, facilitating performance enhancement using adaptive algorithms.

Under HCCA, access to the medium is controlled by the Access Point. HCCA is an enhanced version of the Point Coordination Function (PCF) of the original standard that controls the CFPs. The most important enhancement provided by HCCA is the new concept of Controlled Access Phase or CAP. A CAP is a usually short contention free period that is initiated during a contention period (FIG. 2). An access point can start a CAP by sending a poll or data frame while it finds the medium idle for PIFS. Since PIFS is shorter than AIFS (used by EDCA), the AP is able to interrupt the contention operation and generate a CAP at almost any moment (with at most one packet length delay). A CFP (as described in 802.11) is also considered a CAP (FIG. 2). However, with capability to generate CAPs at any time, there is no need for periodic CFPs. The CAP generation capability is the main feature that we use for providing per-flow QoS. The 802.11e standard does not specify the scheduling discipline that determines when CAPs are generated and leaves it to system developers to devise such a scheme.

[image]

The guaranteed access with bounded delay gives the AP the power to start a contention free access at any time with at most one packet length delay. This feature can be used to provide services for real-time applications that cannot tolerate unbounded delay or high jitter. At the start of a CAP the access point can send either a data frame (downlink CAP) or a poll message (uplink CAP) after sensing the channel idle for PIFS. A CAP may include more than one consecutive frame exchange sequences that are limited by a station or flow specific TXOP.

When data frames are sent downlink, the AP decides for how long it will send frames to a particular destination; for uplink data frames, a station is only allowed to send frames for the duration of the TXOP granted by the AP. If this duration is short, the station must fragment its frames and only send the part that fits in the granted TXOP. If TXOP is set to zero the station is only allowed to send one frame (size limited by other MAC regulations).

The 802.11e standard draft provides flow IDs (Traffic Stream ID) in frame formats to enable per-flow QoS handling. It also specifies that it is the responsibility of stations to setup traffic streams (flows) and request resource reservation. This is done through sending an ADDTS request to the AP and asking for a traffic stream to be setup with specific traffic specifications. The information carried in the ADDTS request is used by the admission control and scheduling functions of the AP. The ADDTS response by AP completes the traffic stream setup procedure. The standard draft specifies the format in which the traffic stream specifications are described. In fact, we found this description to be very thorough. In particular fields such as service interval and start time are very useful in setting up scheduled access and poll messages.

2. CAPS: Controlled Access Phase Scheduling

Given the characteristics of an 802.11e WLAN, we present a unified QoS framework that addresses prominent aspects of a WLAN environment. Our scheduling framework has the following features: 1) Use of virtual packets to combine the task of scheduling uplink and downlink flows of a naturally distributed CSMA/CA environment into a central scheduler that resides in an AP; 2) Application of a GPS-based algorithm and an integrated traffic shaper in a unified HCCA and EDCA queuing framework to provide guaranteed fair channel access to HCCA flows, and sharing the remaining capacity using EDCA (as illustrated in FIG. 2). The following subsections describe the prominent features of our design, which is depicted in FIG. 3, in more detail.

2.1 Centralizing the Scheduling Task: Combined Downlink/Uplink Scheduling

One important feature of CAPS is its ability to centralize the scheduling task in the inherently distributed WLAN environment. In an 802.11 WLAN, the medium is shared between downstream and upstream traffic at all times. Thus, any scheduling discipline must handle packet transmissions from individual stations to the AP (i.e. upstream), and from AP to the stations (i.e. downstream). Downstream packets are available in the AP buffers and can be directly scheduled, while upstream packets reside in the stations generating these packets and cannot be scheduled directly. However, the AP can use upstream traffic specifications, available through signalling or feedback, and schedule poll messages that allow for upstream packet transmission.

The key to realizing the above scheduling concept, is to represent packets from remote stations (i.e. the upstream packets) by “virtual packets” in the AP, then use a single unified scheduler to schedule virtual packets along with real packets (downstream packets). When scheduling virtual packets, the AP issues polling in the appropriate sequence to generate transmission opportunities for upstream packets. We call this mechanism hybrid scheduling because it combines upstream and downstream scheduling in one discipline. The performance of the scheduler will of course depend on the specific discipline used. In fact, the framework can use any conventional single server scheduler with some modifications. We propose to use GPS based fair algorithms such as Start-time Fair Queuing (SFQ) [22], Weighted Fair Queuing (WFQ) [18], or Worst case Fair Weighted Fair Queuing (WF²Q), [21]. For brevity we name these CAPS options as CAPS-SFQ, CAPS-WFQ and CAPS-WF²Q. Using a GPS based algorithm ensures fairness and bounded delay (thus controlled jitter) and increases the capacity [image] of the system for supporting multimedia sessions. As will be shown later we will modify these algorithms to suit them for the proposed framework. We will analyze these algorithms performance and identify the best choice in different situations.

The task of generating virtual packets is performed by a module called Virtual Packet Generator (VPG), as depicted in FIG. 3. VPG uses control plane requests (explicit through ADDTS message or implicit through interpreting SIP, [20], calls in higher layers), or traffic pattern estimation to determine the patterns of virtual packets (or flows) that must be generated. For example, for a voice call, a periodic flow of packets similar to the real traffic is generated by the VPG. The generated virtual packets are classified along with actual downstream packets and are queued and scheduled for service based on the algorithm described in the next section.

Packets that are served by the scheduler are treated differently based on whether they are actual or virtual packets. Actual packets are directly transmitted in a downstream CAP, but for virtual packets an upstream CAP is generated by sending a poll message and assigning the appropriate TXOP to the station whose virtual packet is being served.

2.2 Scheduling, and Traffic Shaping

Using the hybrid scheduling model enabled by virtual packets, we can use a central queuing and scheduling model in the AP, as depicted in FIG. 3. The integrated scheduler/shaper module combines EDCA and HCCA operation to achieve both fairness and service guarantee. In all stations (including the AP), the queuing model comprises all queues for flows with reservation (HCCA queues) plus the 4 (or 8) basic EDCA queues for each prioritized access category.

After each transmission or channel busy period, the scheduler examines the queues with reservation (virtual and actual flow queues) and determines whether a queue must be served. In this step only queues whose traffic is conformant to the declared traffic shape are examined. If a queue is found eligible for HCCA service and is selected by the scheduler, it is given controlled access through a CAP generation. But if no queue is found, the scheduler selects the contention access mode and allows all actual packet queues in the system, including those with non conforming traffic, to contend for accessing the channel using EDCA rules.

When contention is allowed, all queues in the stations will contend for accessing the channel (including the HCCA queues). But in the AP we only allow EDCA queues plus the actual packet HCCA queues to contend; Virtual flows are excluded from contention because their corresponding actual flows in the stations are already involved in contention. The EDCA contention parameters used by contending HCCA queues are chosen locally based on the information collected during session setup.

The operation of CAPS can be divided into three tasks. The first task is admission control and generating virtual packets according to the declared session information. The second task includes time-stamping, pre-shaping and queuing the arriving packets. The third and main task is selecting the packet to be served and controlling the switching between HCCA and EDCA.

Task 1: Generating Virtual Packets & Admission Control

This task processes requests from stations to set up flows for sessions. Admission control rules are applied to determine whether a session can be admitted by the AP. Since admission control is outside the scope of this article we do not discuss it here. In fact, any admission control mechanism that works with fair scheduling algorithms can be used. For an admitted uplink session, this process generates virtual packets using the available information. If service interval Sᵢ and average packet size Pᵢ are specified, virtual flows of size Pᵢ bits are generated every Sᵢ seconds. If Sᵢ is not declared, we can use the declared average rate rᵢ, and generate virtual packets of size Pi every (rᵢ/Pᵢ) seconds. Note that this process provides bandwidth guarantees to flows specified by their average rate requirements. To provide delay guarantees in the system, the maximum burst (bᵢ) size of each flow i must be supplied to the traffic shaper. Limiting the burst size is an essential requirement for providing delay guarantees in any GPS-based schedulers such as weighted-fair queuing and its variants.

One way of increasing the system capacity is to allow bursty transmission through TXOPs and reduce the overhead incurred by poll messages. This is achieved by CAPS by simply using larger virtual packets with proportionally longer service intervals (to keep the average rate constant). For Applications such as Voice-over-IP where periods of silence and activity exist, a consistent stream of polls to silent stations will be wasteful. To address this issue the VPG must stop sending polls after detecting an empty queue (through the queue size field of the received poll response being set to zero or the more_data bit turned off). The VPG will resume generating VPs as soon as it receives a new frame for the session that arrives through EDCA. If EDCA may cause unacceptable delay the VPG can send polls at a lower rate to inquire about the activity of the voice source.

Task 2: Queuing Packets

Packets that are received by the CAPS scheduler are classified into three groups 1) virtual packets for uplink flows with reservations; 2) real packets belonging to downlink flows with reservations; 3) packets with no flow-association and no reservation. The first two types are called HCCA packets in this article and are assigned to HCCA queues. For scheduling purposes the length attribute of these packets must be adjusted to account for the different overheads incurred by each type. Virtual packets require an extra poll message at the beginning of a CAP, so the transmission period for such packets must be increased accordingly.

When a packet without reservation is received, its access category field is examined and the packet is stored in a corresponding EDCA queue. For the HCCA packets, the Traffic Stream ID of the (virtual or real) packet is used to determine its corresponding session queue. Before queuing, the conformance of the arriving HCCA packet to its flow's declared traffic pattern is checked and the packet is properly tagged with an eligibility time indicating when the packet is eligible for HCCA service (section 3 elaborates on this issue more). The packets are then time-stamped with start or finish tags according to the algorithm used in the inner scheduler (e.g. SFQ, WFQ or WF²Q). The packet start and finish times for these inner schedulers (SFQ, WFQ, and WF²Q) are given by:

$$\begin{matrix}{S}_{i}^{k} = max ( {F}_{i}^{k - 1} , V ( t ) ) & ( 1 ) \\ {F}_{i}^{k} = \frac{{L}_{i}^{k}}{{r}_{i}} + {S}_{i}^{k} & ( 2 )\end{matrix}$$

Where Sᵢ^{k} and Fᵢ^{k} are the start and finish timestamps for the k^{th} packet from the i^{th} flow, Lᵢ^{k} is the adjusted packet length, rᵢ is the rate assigned to the flow, and V(t) is the virtual time function. The virtual time is calculated differently for each inner scheduler. For WFQ and WF²Q, V(t) represents the progress time of a GPS scheduler that is fed with the packets from these queues and is calculated as:

$$V ( {t}_{j} - 1 + T ) = V ( {t}_{j} - 1 ) + \frac{T}{{\sum }_{i ∈ {B}_{j}} ( {r}_{i} / R )} , T \leq {t}_{j} - {t}_{j - 1} , j = 2 , 3 , … \qquad ( 3 )$$

where R is the server rate, T is the time between two subsequent events j and j−1 (i.e. packet arrival or departure) in the GPS system and Bⱼ is the set of backlogged sessions (queues) between these events. For SFQ the virtual time is described in a much simpler way as the start tag of the packet in service at time t. At the end of a busy period v(t) is set to zero (or the last packet's finish time).
Task 3: Scheduling and Traffic Shaping

With packets queued in either HCCA or EDCA queues, the main task of CAPS is to determine which mode of operation should be used and which queue must be served at each service time. A service time occurs after a transmission is completed and the AP senses that medium has been idle for one PIFS duration. At this time the algorithm described in FIG. 4 indicates whether a CAP for a virtual or actual packet must be generated, or control should be given to EDCA.

The algorithm requires maintaining a queue budget parameter gᵢ for uplink traffic control. The queue budget parameter keeps track of the lost service time and the available TXOP time for a specific virtual flow at any given service time. Initially, gᵢ is set to zero; it increases with each transmitted poll, and decreases with each response received. The scheduling algorithm is explained in a two-step pseudo code format depicted in FIG. 4.

The algorithm assumes that generated virtual flows are conformant to the reservations made during session setup, but actual downlink or uplink flows may not conform to their previously declared pattern. Therefore, traffic shaping and control is performed differently for actual and [image] [image] virtual flows. For uplink flows we only have an estimate of the flow pattern through virtual flow specifications and must wait for the actual packets to arrive before we can apply traffic shaping. This is achieved through compensation as explained later. For actual downlink flows, we can apply the shaping measures directly to the flows through an eligibility flag that is explained in the next section. The scheduler only serves virtual flows with packets and actual flows with eligible HoL (Head-of-Line) packets. When no such packets are found, control is given to EDCA. Therefore the decision for switching to EDCA is made indirectly through traffic shaping and virtual packet generation processes.

2.3 Implementing the Traffic Shaper

The integrated traffic shaper in the system is needed for downlink actual packets. Since virtual packets are already conformant to a predefined shape (enforced by the VPG), we only need to use the shaper to ensure that actual downlink flows do not exceed their promised HCCA service. This way we make sure that CAPS only assigns the promised service times to HCCA and switches to EDCA for using the remaining capacity. If shapers were not used, mal-behaving downlink flows could take up all the channel capacity and starve the EDCA traffic.

To enforce the shaping decisions on downlink HCCA flows, we add a new time stamp called eligibility_time to each queued packet. Eligibility time is derived based on a token bucket shaper with envelope (rᵢt+bᵢ). Upon arrival, each packet is tagged with the time when it becomes eligible (compared to system time). The inner scheduler only looks at HoL packets whose eligibility time is past the system time. However, for EDCA all HoL packets can contend.

2.4 Lost Service Compensation for Uplink Flows

Traffic shaping for uplink flows is mainly done through generating conformant virtual flows. However, in some cases the length of an uplink packet, sent in response to a poll, may be smaller than that of the virtual packet that generated the poll. In this case the budget gᵢ does not go to zero after receiving the poll response and increases (up to the burst size) by the unused amount of budget. The positive and increased budget for virtual flows is an indicator of lost service for uplink flows. This lost service can be compensated in two ways: 1) “Immediate Compensation” in which the entire budget is assigned in one polled-TXOP when the next virtual packet for this queue is served, 2) “Deferred Compensation” for which the TXOP is always assigned based on the length of the virtual packet currently in service and any excess budget is used to generate additional virtual packets for the same virtual flow. Compensation occurs for the flow when these packets are later served.

With immediate compensation a small virtual packet may result in a large TXOP being assigned to the station to compensate for the lost service. We call this case Long Response (or LR). The LR case may result in a large (but still bounded) difference between CAPS operation and the ideal GPS for a short period of time. We analyze this situation later in this article.

With deferred compensation, since the TXOP assigned to a station as a result of serving a virtual packet is not derived from the budget parameter but from the virtual packet size, we ensure that the long response case does not happen and the subsequent service disturbance is avoided for other flows, as a result the service guarantees for other flows are still valid.

For deferred compensation, a virtual flow that has a positive gᵢ can exchange the accumulated budget with additional virtual packets that are then stored in its queue and will get service at the guaranteed rate. The compensation virtual packet is generated when an indication of non-zero queue size is received either through HCCA or EDCA packets from the station. Deferred Compensation is, in effect, similar to retransmitting a virtual packet (poll message) and re-assigning the TXOP until it is properly responded to. This mechanism isolates the compensation for a specific flow from the rest of the flows and enhances service guarantees. It, however, introduces implementation overhead. Therefore, we only use this option when we do not have a good estimation of uplink flows and the bounds on service discrepancy become unacceptably large. The analysis in section 3 helps us to make a choice more appropriately.

2.5 Adapting to Wireless Channel

Physical channel impairments in a WLAN result in packet loss and consequently retransmission of packets by the MAC layer. If the quality is consistently low, the operational transmission rate for a station may be reduced as well. Channel impairment issues can be dealt with in many ways. One method is to use a lead/lag model as described in earlier works on single direction schedulers such as those described in [3], [4] or [6]. These models rely on detecting channel quality beforehand and lending one stations transmission time to another to avoid transmitting in a bad channel. A lead/lag counter is maintained and the stations that are leading in their service will gradually give back service to the lagging stations. Such methods are not usually applicable if good channel estimations are not available. They also cannot be applied when uplink flows are concerned since AP may not know of stations' conditions. As a result we rely on the retransmission feature of the MAC and adapt a simpler model of readjustment of scheduling task in order to maintain fairness. If channel monitoring is efficiently possible in WLANs, the lead/lag method can also be used.

To deal with packet loss, the MAC layer can retransmit a packet a few times until it arrives at the receiver or is dropped after n attempts. If retransmission happens during a CAP it may disturb the fairness of the scheduler since a station may take longer than expected to transmit the packet. To counter this problem we have several options: the first option is to avoid immediate retransmission and wait until the next service round for this queue. This is automatically achieved for virtual packets by the deferred compensation method discussed above. For downlink packets the HoL packet's time stamps are recalculated as if it was a new packet. This method prevents problems in this flow from disturbing other flows and ensures that service guarantees are still valid. Also, a good side effect is that immediate retransmission on the bad channel is avoided and situation may improve till the next service round.

Another option to maintain fairness in presence of retransmission is to move the packet that incurred problem to a special queue set up for retransmission (or to an EDCA queue) with separate reservations. This method is similar to Server Based Fair Algorithm (SBFA) described in [23]. This, in effect, isolates the effect of packet loss and retransmission from all other queues, and from the next packets in the same queue.

The re-adjustment of packet time stamps, as described above, must be reflected in virtual time calculation of the inner scheduler as well. Implementing this policy for CAPS-SFQ is very simple as its virtual time is calculated using real events from the scheduler; however for CAPS-WFQ and CAPS-WF²Q, applying the length adjustments to virtual time, though feasible, is computationally expensive because virtual time is calculated from simulating a GPS server.

3. Performance Guarantee Analysis

Since CAPS is based on GPS and uses fair queuing algorithms, we expect it to be able to guarantee channel resources for each session. We elaborate this fact by proving that the difference between CAPS and ideal unidirectional GPS is bounded under different conditions and using different inner schedulers. To examine this point we analyze the algorithm under worst case scenarios where the order of served packets in CAPS is different from the ideal order of its unidirectional inner scheduler, hence from GPS.

CAPS deviates from the ideal order of a unidirectional inner scheduler in two cases, when immediate compensation is used and the response to a poll message is longer than the corresponding virtual packet (i.e. Long Repose, LR, case), and when a short response is sent in response to a longer virtual packet (i.e. Short Response, SR, case) in both immediate and deferred compensation modes. If each generated virtual flow exactly matches its corresponding uplink flow (poll response), CAPS behavior is equal to its inner scheduler. In this case all the performance bounds of the inner scheduler are applicable to CAPS as well. But in the case of LR and SR, the order of packets in CAPS and its inner scheduler may be different; as a result new performance bounds may be found for CAPS. In this section we first analyze the LR case for both immediate and deferred compensation options. We show that deferred compensation is indeed the preferred choice when strict performance guarantees are needed. Consequently we analyze the SR case under deferred compensation for several inner scheduler options.

3.1 Long Response Case: Immediate and Deferred Compensation

Using immediate compensation a virtual flow queue may gather a large budget if its virtual packets are responded with short or no packets (null packets) for a long time. Since in immediate compensation the entire budget is assigned in one TXOP in each poll, the actual uplink frames corresponding to virtual frames j, may be of the maximum allowed size and larger in size than the corresponding virtual frames; this results in an order of service in CAPS that is different from its ideal inner scheduler and GPS. For such a case, the difference in order and service progress is bounded as will be shown. For this section we will consider CAPS-WFQ; a similar analysis is applicable to CAPS-SFQ and CAPS-WF²Q, and resulting bound are very similar.

Consider a packet from queue k that is scheduled after a number of virtual packets j. If the virtual flows utilize their entire assigned TXOP in response to the short virtual packets, we may face a situation in which many frames from uplink flows j may be served ahead of frame k in CAPS, while in GPS k would finish service before all these packets. For example, for CAPS-WFQ, this order of scheduling is created if several virtual frames from flows j have smaller finish times than frame k. The finish times are calculated using the virtual packet lengths.

With immediate compensation, responses to virtual packets may be as long as the burst size (enforced by the budget parameter), and given that the scheduler works with virtual packet lengths, we may have more virtual packets scheduled before k and after the bursty response. There is also one other situation that can add to the difference between CAPS-WFQ and GPS. This situation is the same scenario mentioned in [17] that describes the inherent difference of WFQ and GPS; one example of this case is when a frame m arrives in an empty system and starts service under WFQ, but a short time later a frame k arrives (in another queue) and its calculated finish time is less than that of m. Since m has already started the service, k must wait until the end of service for m. Note that this situation may only happen for maximum one frame m. Given the described situation we can combine this case with the case where several small virtual packets from queues j are scheduled ahead of k and after m, but their actual frames are served after k in GPS. Considering the above worst case scenario the following theorem can be proved:

Theorem 1: if tᵢ, and uᵢ denote the finish time for frame i in CAPS-WFQ and GPS respectively, the following inequality holds for frame k (as described above) if immediate compensation is used:

$${t}_{k} - {u}_{k} \leq \frac{{\sum }_{j ∈ V} ( {b}_{j} )}{R} - \frac{{\sum }_{j ∈ V} ( {V}_{j}^{min} )}{R} + \frac{{L}_{max}}{R} \qquad ( 4 )$$

Lₘₐₓ is the maximum packet length in the system, R is the channel rate and vⱼ^{min} is the minimum virtual packet length of flow j. We also assume that the maximum response size to any virtual packet from flows i is bounded by the burst size bi (according to immediate compensation rules).

Proof: denoting the amount of traffic served from queue i as Sᵢ, and from all queues as S, we know that using immediate compensation the maximum amount of traffic that is served in CAPS-WFQ from all virtual queues j between the end of frame m (tₘ) and beginning of frame k (tₖ−Lₖ/R) includes: 1) a burst size response to a virtual packet (bⱼ) 2) sum of normal size responses (Wⱼ) to the rest of virtual packets scheduled before k but after the virtual packet that resulted in the bursty response. Thus we have:
Sⱼ(tₗ)−Sⱼ(tₖ−Lₖ/R)≦Wⱼ+bⱼ (5)
Also, denoting as X the sum of all traffic from downlink packets served in CAPS-WFQ between m and k (thus served between tₘ and tₖ−Lₖ/R ), and taking a sum over all virtual flows traffic we have the following (V is the set of all VP queues, except queue k):

$$S ( {t}_{k} - {L}_{k} / R ) - S ( {t}_{m} ) \leq {\sum }_{j ∈ V} ( {W}_{i} + {b}_{j} ) + X \qquad ( 6 )$$

And since all packets are served at rate R, we have:

$${t}_{k} - {L}_{k} / R - {t}_{m} \leq \frac{X + {\sum }_{j ∈ V} ( {W}_{i} + {b}_{j} )}{R} \qquad ( 7 )$$

For the flows j virtual packets to have been scheduled before k by CAPS-WFQ, they must have all arrived and departed before uₖ in the simulated GPS system, this includes virtual packets that resulted in a bursty response as well as those that incurred normal size responses (Wⱼ). To conceive the worst case we can assume the smallest sizes , i.e., Vᵢ^{min}, for the virtual packets that resulted in bursty response. Therefore, knowing that frame m arrives (at tₘ−Lₘ/R) before other packets that contribute to the sum of traffic in (6) and knowing that k finishes after all these packets in GPS we have:

$${u}_{k} \geq \frac{{\sum }_{j ∈ V} ( {V}_{j}^{min} + {W}_{j} ) + X + {L}_{k}}{R} + ( {t}_{m} - \frac{{L}_{m}}{R} ) \qquad ( 8 )$$

Assuming maximum possible length for m, the theorem follows from deducting (8) from (7). Note that in (4) all the values for packet lengths and burst sizes already include the adjustments for MAC operation overhead (i.e. polling and acknowledgement). Q.E.D.

Expression (4) shows that the difference between service time in CAPS-WFQ and GPS is bounded (similar expressions can easily be found for SFQ and WF²Q). We can also show that the backlog of each session under CAPS is more than GPS by a bounded amount. And since GPS is an ideal system, we will have bounded backlog for any session with reservation in CAPS. Since backlog is also the difference between arrival and service curves, it is enough for our purpose to show that the difference between the served traffic in CAPS and GPS is bounded.

Theorem 2: For any given time τ the difference between the amount of served traffic in CAPS-WFQ with immediate compensation (denoted Ŝⱼ(0, τ)) and GPS (denoted Sⱼ(0, τ)) is bounded by the following:

$${S}_{j} ( 0 , τ ) - {\hat{S}}_{j} ( 0 , τ ) \leq {\sum }_{j ∈ V} ( {b}_{j} ) - {\sum }_{j ∈ V} ( {V}_{j}^{min} ) + {L}_{max} \qquad ( 9 )$$

Proof: Let's assume that a packet of size L that finishes service at time τ in GPS, completes service at t+L/R in CAPS. Since Packets are served in the same order in both systems (assuming all flows are conformant) we have:
Sⱼ(0, τ)=Ŝⱼ(0, t+L/R) (10)
If for simplicity we rewrite Theorem 1 as tᵢ−uᵢ≦A, we will have: (t+L/R)−A≦τ. Also, from (10) we have
Sⱼ(0, t+L/R−A)≦Sⱼ(0, τ)=Ŝⱼ(0, t+L/R)=Ŝⱼ(0, t)+L (11)
Since we know that the slope of Sⱼ is at most R:
Sⱼ(0, t+L/R−A)≦Sⱼ(0, t)+L−A.R; (12)
deducting (11) from (12), we will have Sⱼ(0, t)−Ŝⱼ(0, t)≦A.R, and the theorem follows. Q.E.D.

With Theorems 1 and 2 we prove that CAPS performance is different from GPS by a bounded amount, thus proving that it can indeed provide fair and guaranteed services, as is possible with GPS and WFQ. However, as is seen from (4) and (9), in certain situations we may encounter a large. yet bounded, deviation from GPS operation. This is the case when the difference of the sum of allowed burst sizes and minimum VP sizes amounts to a large value. Note that the allowed burst sizes are already limited by the maximum TXOP limit (˜8.1 msec). Nevertheless, if for such situations we find the bounds to be too large, we must use deferred compensation which has higher implementation complexity but eliminates the LR case altogether.

With deferred compensation the length of the frame that is sent in response to a poll is always equal or less than that of the virtual packet that generated the poll. This means that the LR case is in fact eliminated. In certain cases where we have virtual packet sizes that match the corresponding uplink packet size, we can show that deferred compensation can provide delay bounds equal to that of an ideal unidirectional scheduler, even if some packets are not present and polls are not responded to. For example, for CAPS-WFQ, the worst case situation that has been described earlier reduces to the case where only one long packet may be served ahead of its order in WFQ if it starts service before other smaller packets arrive. This situation which is in fact similar to the worst case in WFQ system results in the following bounds:

$${t}_{k} - {u}_{k} \leq \frac{{L}_{max}}{R} \qquad ( 13 )$$

The above expression directly follows from the proof from Theorem 1 with the knowledge that the service orders in CAPS strictly follows the finish time calculations based on GPS (except for the explained worst case packet m). Consequently we can revisit theorem 2 and derive the following inequality for the deferred compensation case under the same conditions:
Sⱼ(0, τ)−Ŝⱼ(0, τ)≦Lₘₐₓ (14)

Expression (14) is simply proved by following the proof for (9) and replacing A with Lₘₐₓ.

Deferred compensation eliminates the LR case and can considerably improve the bounds on backlog and delay in worst case situations. Therefore we argue that the implementation overhead of deferred compensation is acceptable if a precise pattern for uplink flows is not available for

[image]

VP generation. Given this argument we assume that deferred compensation is used and continue the analysis of CAPS in SR case under this assumption.

3.2 Performance Analysis of CAPS with Deferred Compensation

In this section we examine the deviation of CAPS operation from its inner scheduler in the SR case and derive the performance bounds for three inner schedulers, WFQ, WF²Q, and SFQ. As mentioned before, the LR case is eliminated when deferred compensation is used. It is also important to note that the algorithm corrects the projected start and finish times of the next packets in the queues after detecting a SR case, preventing the propagation of the SR case.

SR case for CAPS-WFQ

A worst case scenario for CAPS-WFQ with short response situation happens when a long virtual packet with finish time uₖ^{v} is scheduled for a short uplink packet with ideal finish time of uₖ under GPS. This means that all packets j with GPS finish times uₖ<uⱼ<uₖ^{v} were supposed to finish service after k in GPS, but under CAPS-WFQ they are sent ahead of k since uⱼ<uₖ^{v}. With these assumptions we can now prove the following theorem:

Theorem 3: if tₖ, and uₖ denote the finish time for frame k in CAPS-WFQ and GPS respectively, the following inequality holds for frame k if deferred compensation is used:

$${t}_{k} - {u}_{k} \leq \frac{{L}_{max}}{R} + \frac{{\sum }_{j ∈ Q , j \neq k} {r}_{j}}{R} ( \frac{{L}_{k}^{v} - {L}_{k }}{{r}_{k}} ) \\ Q \text{:} the set of all queues \qquad ( 15 )$$

Proof: To picture the worst case situation, we consider a busy period in which all queues in the system are backlogged for the duration of time in which CAPS service order is different from GPS finish times. Also consider packet i to have been the last packet served before k with uᵢ<uₖ. The maximum difference happens when we consider that for the duration between uₖ and uₖ^{v} all other queues always have packets for transmission. With this assumption we consider two sets of packets, S1 and S2 that are sent ahead of k in CAPS but finish before k in GPS (FIG. 5). S1 includes packets that start service in GPS after i and before k and finish an infinitely small time ε after uₖ. The set S2 includes packets that start and finish between uₖ and uₖ^{v}. All queues being backlogged we find the size of S2 traffic as:

$${S}_{2} \leq {\sum }_{j ∈ Q , j \neq k} \{ {r}_{j} \cdot ( \frac{{L}_{k}^{v} - {L}_{k}}{{r}_{k}} ) \} \qquad ( 16 )$$

The set S1 includes all packets j that have uₖ<uⱼ<uₖ+ε. Assuming a hypothetical set S1′ that includes S1 and a packet k′ with uₖ′=uₖ′+ε, we know that packets in S1′ being served in WFQ order, is equivalent to CAPS-WFQ serving S1 and packet k. Therefore, we can use the property of WFQ, in terms of its difference with GPS, and write the following for packet k′ in set S1′:

$${t}_{k}^{′} - {u}_{k}^{′} \leq \frac{{L}_{max}}{R} , thus we have \text{:} {t}_{k}^{′} - {u}_{k} \leq \frac{{L}_{max}}{R} - ɛ \qquad ( 17 )$$

Knowing that packet i was served before packets in set S1 and packet k′, and given that packets k′ is of length Lₖ, we have tₖ′=tᵢ+(Sₗ+Lₖ)/R, where Sₗ denotes the amount of traffic in S1. Combining with (17) we rewrite this equation as:

$${t}_{i} - {u}_{k} \leq \frac{{L}_{max} - {S}_{1} - {L}_{k}}{R} - ɛ \qquad ( 18 )$$

Since packet k in CAPS-WFQ is served after all packets in S1 and S2 and packet i, and the service rate is R, using (16) we find its finish time as:

$${t}_{k} = {t}_{i} + \frac{{S}_{1} + {S}_{2} + {L}_{k}}{R} \leq {t}_{i} + \frac{{S}_{1} + {L}_{k}}{R} + \frac{{\sum }_{j ∈ Q , j \neq k} \{ {r}_{j} \cdot ( \frac{{L}_{k}^{v} - {L}_{k}}{{r}_{k}} ) \}}{R} \qquad ( 19 )$$

Deducting (19) from (18) and choosing ε close to zero the theorem follows. Q.E.D.

As it is seen from (15), packets in set S1 have no effect in increasing the deviation of CAPS from GPS. (15) shows that this deviation may become large if rₖ is small or the difference of virtual and actual packet sizes is large. This bound is, however, much smaller than what we found for the LR case. It also becomes smaller if precise knowledge of uplink flows is available.

SR case for CAPS-WF²Q

WF²Q uses the same finish times as in WFQ; however, when scheduling packets according to their finish time, it only considers those packets that have already started service in the corresponding GPS at the scheduling moment. This mechanism positively affects the service difference bounds for CAPS in some situations.

The worst case scenario for CAPS-WF²Q is more or less the same as in CAPS-WFQ except for the packets that are served during (uₖ, uₖ^{v}). These packets, although have uⱼ<uₖ^{v}, may or may not have started service at the moment when the virtual packet k is eligible for service (FIG. 5). If these packets have started service under GPS, the service difference bound for CAPS-WF²Q is exactly like CAPS-WFQ, described in (15). Lower bounds may exist depending on the packet sizes for queues j. To examine this case assume that until packet i everything was in WF²Q order; at tᵢ, CAPS can be either ahead of GPS (tᵢ<uᵢ) or be lagging at most Lₘₐₓ/R according to [21]. To conceive the worst case, we want to have more packets from queues j eligible, thus we assume that CAPS is lagging.

Similar to the proof in theorem 3 we consider a set S1 whose packets j have finish times: uₖ<uⱼ<uₖ+ε. From theorem 3 we know that the traffic in S1 does not increase the deviation of CAPS and GPS. So we find the traffic served during (uₖ, uₖ^{v}). At the beginning of this period, when all the packets in S1 have been served, the CAPS service progress time, T_{CAPS}, is assumed as lagging behind GPS progress time, TGPS, and is found as:

$${T}_{CAPS} = {t}_{i} + \frac{{S}_{1} + {L}_{k}}{R} \leq {u}_{j} + \frac{{L}_{max}}{R} = {T}_{GPS} + \frac{{L}_{max}}{R} \qquad ( 20 )$$

where uⱼ is the GPS finish time of the packets in S1. Inequality (20) means that scheduling time is behind GPS progress time and another set of packets from all queues may be served ahead of k, adding to the difference between CAPS and GPS. To worsen the situation we assume that queues j have (infinitesimally) small packets like a fluid system; these packets are served at rate Σ_{j∈Q, j≠k}^{r}ⱼ in GPS, and rate R in CAPS, thus CAPS advances faster and may reach and lead ahead of GPS, making packets from queues j ineligible, and allowing packet k to be serviced. We also note that just before the moment when CAPS reaches GPS, one more packet can be served. We denote the length of this packet as L¹. Considering the amount of traffic that can be served in (T_{CAPS}−T_{GPS}) as Sₛ, we know that the maximum traffic that can be served between uₖ and u^{v}ₖ is:

$${S}_{m} = min \{ {S}_{s} + {L}^{l} , ( {\sum }_{j ∈ Q , j \neq k} {r}_{j} ) \cdot ( \frac{{L}_{k}^{v} - {L}_{k}}{{r}_{k}} ) \} \qquad ( 21 )$$

and Sₛ is found from:

$${T}_{CAPS}^{max 1} + \frac{{S}_{s}}{R} = {T}_{GPS}^{max 1} + \frac{{S}_{s}}{{\sum }_{j ∈ Q , j \neq k} {r}_{j}} ⇒ {S}_{s} \leq \frac{{\sum }_{j ∈ Q , j \neq k} {r}_{j}}{R - {\sum }_{j ∈ Q , j \neq k} {r}_{j}} {L}_{max} \qquad ( 22 )$$

The packet with length L¹ must have a finish time less than u^{v}ₖ to be counted in CAPS and GPS difference. Since this packet is sent at rate R, we can calculate its maximum allowable size as ‘R multiplied by allowed time’:

$${L}^{l} = R \cdot ( {u}_{k}^{v} - {u}_{k} - \frac{{S}_{s}}{{\sum }_{j ∈ Q , j \neq k} {r}_{j}} ) = R \cdot ( \frac{{L}_{k}^{v} - {L}_{k}}{{r}_{k}} - \frac{{S}_{s}}{{\sum }_{j ∈ Q , j \neq k} {r}_{j}} ) \qquad ( 23 )$$

Having found Sₛ and L¹ we can conclude that the maximum amount of traffic served ahead of k is given by S_{w} as:

$${S}_{w} = {S}_{1} + min \{ {S}_{s} + {L}^{l} , {\sum }_{j ∈ Q , j \neq k} {r}_{j} \cdot ( \frac{{L}_{k}^{v} - {L}_{k}}{{r}_{k}} ) \} \qquad ( 24 )$$

From (24) and (18), (that also holds for CAPS-WF²Q) and knowing that

$${t}_{k} - {t}_{i} \leq \frac{{S}_{w}}{R} + \frac{{L}_{k}}{R}$$

have indeed proved the following theorem:

Theorem 4: if tᵢ, and uᵢ denote the finish time for frame i in CAPS-WF²Q and GPS respectively, the following inequality holds for frame k if deferred compensation is used:

$${t}_{k} - {u}_{k} \leq \frac{{S}_{w}}{R} + \frac{{L}_{max}}{R} \qquad ( 25 )$$

The bound in (25) is indeed less than or equal to what is expressed in (15); thus, it may well depend on the flow parameters to determine whether using WF² Q is helpful to reduce the effects of imprecise virtual packet generation. In the next subsection we study SFQ and find that it may in fact be a better choice for reducing the effect of virtual/actual flow mismatch.

SR case for CAPS-SFQ

For CAPS-SFQ with deferred compensation the short response case can be contained and its negative effects eliminated. In fact we prove that the following theorem holds for CAPS-SFQ.
Theorem 5: if tᵢ, and uᵢ denote the finish time for frame i in CAPS-SFQ and GPS respectively, the following inequality holds for frame k if deferred compensation is used:

$${t}_{k} - {u}_{k} \leq \frac{{\sum }_{j ∈ Q , j \neq k} {L}_{j}^{max}}{R} + \frac{{L}_{k}}{R} - \frac{{L}_{k}}{{r}_{k}} \qquad ( 26 )$$

Proof: We first explain that we can eliminate the effect of SR case on CAPS-SFQ. To see this point, notice that in SFQ packets are time-stamped with start and finish times as follows for the i'th packet of flow k that arrives at time Aᵢ^{k}:
Sᵢ^{k}=max{V(Aᵢ^{k}),Fᵢ₋₁^{k}}; Fᵢ^{k}=Sᵢ^{k}+Lᵢ/rₖ (27)
where Lᵢ denotes the packet size, and V(.) is the system virtual time, taken to be the start tag of the packet currently being served. As a modification to SFQ, in CAPS-SFQ, if a short response occurs, the finish time of the current virtual packet can be adjusted to reflect the actual size of the uplink packet. This means that the next virtual packet backlogged in the queue will have the correct start time tag. Since in SFQ packets are served in order of start time, the SR case does not change the order of service in CAPS-SFQ from the inner ideal unidirectional SFQ scheduler. As a result we know that the difference between CAPS-SFQ and GPS is the same as the difference between SFQ and GPS. Given that in GPS a packet i that arrives at HoL is served after Lᵢ/rₖ. And knowing that in worst case scenario for SFQ ([22]) such packet may be served after maximum packets from all other queues we can directly derive (26). Q.E.D.

From the bounds found in this section we see that the delay bound of WFQ and WF²Q worsens in WLANs, compared to their bounds found for an ideal unidirectional scenario. This is not the case for SFQ. Also, as it is shown in [22], the delay bound of ideal WFQ or WF²Q is better than SFQ only for high bitrate flows, in schedulers with a large number of session. For low bitrate flows SFQ provides a better delay bound. Given the bounds found above, this advantage of SFQ is strengthened with the increased deviation of WFQ or WF²Q from GPS in non-ideal cases. These advantages, along with ease of implementation and adoption of retransmission policies make CAPS-SFQ the best choice for our framework.

4. Performance Evaluation

To evaluate service guarantee features of CAPS and measure its performance under different conditions we conducted several experiments using an OPNET-based 802.11e simulator that we have developed. We assumed an 802.11b physical layer for our experiment. We compared the results from CAPS operation with those that are achieved by the standard's EDCA mechanism and the TGe scheduler. Some of the performance gains achieved by our algorithm, such as total throughput increase, are similar to those of other HCCA algorithms such as TGe and other works [13] [14]. However, the TGe scheduler has been shown to be very inefficient for VBR traffic [13] [14], and we have demonstrated this fact in some of our experiments as well. Also, contrary to CAPS, the algorithms presented in [13] [14] are not based on fair scheduling and cannot provide short term fairness and protection to individual flows. In this section, we present several experiments comparing CAPS with solutions like TGe and in particular with EDCA, which is the most likely contender with methods such as CAPS and is the easiest QoS solution to deploy.

It is important to note that for proving the ability of CAPS to achieve fair and guaranteed services similar to GPS we considered absolute worst case scenarios. In practice, these worst case scenarios do not happen very often and we can achieve much better average delay and rate guarantee performance using CAPS. Through our experiments we demonstrate four advantages of CAPS in providing guaranteed throughput, protection from background and from same class traffic, and increase in system capacity for multimedia applications.

The results in this section are valid for all three options of CAPS-WFQ, CAPS-SFQ and CAPS-WF²Q, unless stated otherwise. In fact we see that in most cases the worst case scenarios of the previous section do not occur easily and the average or near worst case behavior of all three options of CAPS are very similar. To verify this point we conducted an experiment in which the maximum delay for one 500 Kbps video flow was measured as the number of HCCA flows (each 500 Kbps, with 2000B packets) increased. We simulated the SR case by generating 4000B virtual packets for video packets of average size 700B. The results, depicted in FIG. 6, show that the near worst case behavior is very similar for WFQ, WF²Q and modified SFQ.

[image]

To demonstrate the ability of CAPS to guarantee a certain bitrate and share the remaining capacity using EDCA, we conducted another experiment and observed the achieved throughput of a CAPS flow with 100 Kbps reservation and another flow with EDCA access. All the stations in this experiment were data sources with rate 200 Kbps (200 Bytes packets, with exponential inter-arrival, and highest EDCA priority). In different steps of the experiment we increased the number of stations to increase the load until the WLAN enters saturation. The results, depicted in FIG. 7, show that at low loads all stations can get their 200 Kbps traffic through. However, as the load increases, the EDCA flow suffers from collision and problems of contention access, while the flow with CAPS reservation maintains at least its guaranteed rate (i.e. 100 Kbps).

In another set of experiments we considered a 512 Kbps H.264 Video traffic and observed the delay its packets incurred as we increased the background traffic of all classes (including voice). Although the video was a variable bitrate media which caused SR case, we still achieved a very controlled delay performance using CAPS (all options) compared to TGe and EDCA. The results [image] shown in FIG. 8 confirm that the flow is protected from the background traffic. It also shows the inherent inefficiency of the TGe scheduler in supporting VBR traffic such as video.

[image]

[image]

To get more insight into the delay performance of each QoS solution we plotted the cumulative distribution function (CDF) of the measured delay from one of the above experiments (the case with 10 Mbps background traffic) in FIG. 9. It is seen that, for example, a delay bound of 100 msec results in significant packet loss for TGe and EDCA solutions.

To examine the delay performance of CAPS we evaluated a voice only WLAN and measured the number of G.711 voice flows that could be supported in an 11 Mbps WLAN (e.g. in an 802.11b PHY). The voice flows were 64 Kbps (80 Kbps with RTP and IP overhead) with a rate of 50 packets per second. We increased the default minimum and maximum contention window sizes for EDCA voice access category to let it accommodate more stations. Without this increase EDCA would fail very quickly. We also allowed larger virtual packets, but with longer service intervals to allow for bursty operation (EDCA by default uses bursty operation for voice category). As is shown in FIG. 10, when CAPS is used the average and maximum delay for voice sessions remains controlled for a higher number of voice sessions, demonstrating a substantial capacity boost despite the significant overhead of poll messages. For example, if the maximum specified delay for voice sessions is restricted to 100 ms within the WLAN, EDCA can admit no more than 20 flows while CAPS can serve more than 45 voice flows (CAPS-WFQ and CAPS-WF2Q performs identically, but slightly different from CAPS-SFQ).

[image]

In the last set of experiments we examined the per-session services of CAPS versus the aggregate services of EDCA. We considered a WLAN in which the background data traffic was fixed but the number of video flows increased in the channel. We observed the delay incurred by a low bitrate video such as a 64 Kbps cell-phone size video, while some higher bitrate video flows were being added to the WLAN. As shown in FIG. 11, CAPS is able to protect the low bitrate stream against higher bit-rate flows from the same traffic class. Meanwhile, EDCA fails to isolate this flow and unfairly allows the higher bitrate flows to degrade the quality of lower bitrate flows. This deficiency in EDCA is because of its inherent aggregate service differentiation which fails to achieve flow isolation within the same traffic class.

[image]

5. Concluding Remarks

Providing per-session QoS in WLANs requires special measures that are addressed by our proposed CAPS framework. The proposed design enables centralized scheduling of upstream and downstream flows in the access point. It also facilitates on demand use of controlled access phases under HCCA, while allowing EDCA operation for the remaining capacity. This feature allows very efficient service guarantee for time sensitive flows even under heavy traffic conditions. In particular applications such as real-time Voice and Video over WLAN will greatly benefit from this design because of the inherent similarity of their operational environment to the cases targeted by this design.

Currently, we are examining the use of CAPS framework in similar shared medium environments such as IEEE 802.16. Also, a detailed account of CAPS operation under multi-rate physical layer is in preparation for publication. Integrating the presented design with the power management features of 802.11e is also an open issue to be further studied. The flexibility provided by the combined uplink/downlink scheduling of CAPS can also be used to employ cross-layer optimizations in the MAC using information from application and physical layers.

6. References

[1] Wireless LAN Medium Access Control (MAC) and Physical Layer (PHY) specifications. ANSI/IEEE Std 802.11: 1999 (E) Part 11, ISO/IEC 8802-11, 1999.
[2] IEEE Standard 802.11e/ Amendment 8, “Medium Access Control (MAC) Quality of Service (QoS) Enhancements,” July 2005.
[3] Thyagarajan Nandagopal, Sonwu Lu ,Vaduvur , A Unified Architecture for the Design and Evaluation of Wireless Fair Queueing Algorithms, Bharghavan, ACM Mobicom 99.
[4] S. Lu, T. Nandagopal and V. Bharghavan, Fair scheduling in wireless packet networks, in: ACM MOBICOM '98 (October 1997).
[5] S. Lu, V. Bharghavan and R. Srikant, Fair scheduling in wireless packet networks, in: ACM SIGCOMM '97 (August 1997).
[6] T. S. Ng, I. Stoica and H. Zhang, Packet Fair Queueing Algorithms For Wireless Networks With Location-Dependent Errors, in: IEEE INFOCOM '98 (March 1998).
[7] A. Boukerche, and T. Dash “Performance Evaluation of a Generalized Hybrid TDMA/CDMA Protocol for Wireless Multimedia with QoS Adaptation”, Computer Communication, Vol. 28, pp. 1468-1480, 2005.
[8] A. Boukerche, T. Dash, and C. M Pinotti “Performance Analysis of a Novel Hybrid Push-Pull Algorithm with QoS Adaptations in Wireless Networks”, Performance Evaluation, Vol. 60, pp. 201-221, 2005
[9] Yuan Yuan, Daqing Gu, William Arbaugh, Jinyun Zhang, Achieving Fair Scheduling Over Error-Prone Channels in Multirate WLANs Wireless Networks, Communications and Mobile Computing, 2005 International Conference on Volume 1, 13-16 June 2005 Page(s):698- 703
[10] Zhimei Jiang, N.K. Shankaranarayana , Channel Quality Dependent Scheduling for Flexible Wireless Resource Management, Global Telecommunications Conference, 2001. GLOBECOM '01. IEEE Volume 6, 25-29 November 2001 Page(s):3633- 3638 vol.6
[11] Qiang Ni, Lamia Romdhani, and Thierry Turletti. ,A Survey of QoS Enhancements for IEEE 802.11 Wireless LAN, Wiley Journal of Wireless Communication and Mobile Computing (JWCMC), John Wiley and Sons Ltd., 2004; Volume 4, Issue 5: 547-566.
[12] Qiang Ni, Performance Analysis and Enhancements for IEEE 802.11e Wireless Networks, IEEE Networks, August 2005
[13] P. Ansel, Q. Ni, and T. Turletti, “An efficient scheduling scheme for IEEE 802.11e,” WiOpt'04: Modeling and Optimization in Mobile, AdHoc and Wireless Networks, 2004
[14] Grilo A., Macedo M., and Nunes M, “A Scheduling Algorithm for QoS Support in IEEE 802.11e Networks”, IEEE Wireless Communications, pp. 36-43, June 2003
[15] Ranasinghe, R. S.; Andrew, L. L. H.; Hayes, D. A.; Everitt, D. , Scheduling Disciplines For Multimedia Wlans: Embedded Round Robin And Wireless Dual Queue, Communications, 2001. ICC 2001. IEEE International Conf. on, Volume: 4, 11-14 June 2001 pp:1243-1248
[16] Pattara-Atikom, W.; Krishnamurthy, P.; Banerjee, S., Distributed Mechanisms For Quality Of Service In Wireless Lans, Wireless Communications, IEEE, Vol: 10 , Issue: 3 , June 2003 pp:26-34
[17] Pourmohammadi Fallah Y., Alnuweiri H., A Controlled-Access Scheduling Mechanism For QoS Provisioning In IEEE 802.11e Wireless LANs ACM international workshop on Quality of service & security in wireless and mobile networks Q2SWinet '05, Pages: 122-129
[18] A. Parekh and R. Gallager, A Generalized Processor Sharing Approach to Flow Control in Integrated Services Networks: The Single-Node Case, IEEE/ACM Trans. on Networking, vol. 1, no. 3, pp. 344-357, June 93.
[19] Dong, X. J.; Ergen, M.; Varaiya, P.; Puri, A., Improving The Aggregate Throughput Of Access Points In IEEE 802.11 Wireless Lans, Local Computer Networks, 2003. LCN '03. Proceedings. 28th Annual IEEE International Conference on, 20-24 Oct. 2003 Page(s):682-690
[20] J. Rosenberg, et. al., SIP: Session Initiation Protocol, RFC 3261, June 2002
[21] Bennett, J. C. R.; Hui Zhang, WF²Q: Worst-Case Fair Weighted Fair Queueing, INFOCOM '96. Fifteenth Annual Joint Conference of the IEEE Computer Societies. Networking the Next Generation. Proceedings IEEE
[22] Goyal, P.; Vin, H.M.; Haichen Cheng; Start-Time Fair Queueing: A Scheduling Algorithm For Integrated Services Packet Switching Networks, Networking, IEEE/ACM Transactions on, Volume 5, Issue 5, October 1997 Page(s): 690-704 Volume 1, 24-28 March 1996 Page(s):120-128 vol.1
[23] P. Ramanathan and P. Agrawal, Adapting Packet Fair Queueing Algorithms To Wireless Networks, in: ACM MOBICOM '98 (October 1998).
   Yaser Pourmohammadi Fallah is currently a PhD student at the University of British Columbia, Canada, and pursuing research in the field of Wireless Communication Networks. Pourmohammadi-Fallah obtained his MASc in Electrical Engineering from the University of British Columbia, where he performed research on QoS-aware multimedia streaming over the Internet. He is a member of the Standards Council of Canada committee for MPEG-4 advancement.
   Hussein Alnuweiri is a professor in the Department of Electrical and Computer Engineering at the University of British Columbia. His main research interests cover all aspects of traffic engineering and QoS mechanisms in packet networks including constraint-based routing protocols, scheduling algorithms, future wireless networks, switching and routing in optical networks, and real-time multimedia communications. Alnuweiri obtained his PhD in computer engineering from the University of Southern California, Los Angeles. He holds two U.S. patents.

The following papers include relevant information. These papers are hereby incorporated herein by reference. It is to be understood that some features described in these papers may not be required in all embodiments of the invention.
“A Unified Scheduling Approach for Guaranteed Services over IEEE 802.11e Wireless LANs” published on Oct. 25, 2004; Broadnets 2004 conference;
“A Controlled-Access Scheduling Mechanism for QoS Provisioning in IEEE 802.11e Wireless LANs” submitted to MSWiM conference, the Q2SWinet workshop, published on Oct. 11, 2005;
“Performance Analysis of Controlled Access Phase Scheduling Scheme for Per-Session QoS Provisioning in IEEE 802.11e Wireless LANs” submitted to WCNC 2006 (April 2006), submission date: Sep. 18, 2005;
“Per-Session QoS Provisioning for Voice and Multimedia in IEEE 802.11e Wireless LANs” submitted to Wireless Communications magazine, the special issue on Voice over WLAN. (April 2006), submission date: Aug. 1, 2005.

Certain implementations of the invention comprise computer processors which execute software instructions which cause the processors to perform a method of the invention. For example, one or more processors in an AP may implement the methods described herein by executing software instructions in a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted. The invention may also be provided in the form of signals carrying computer executable instructions that are being carried on digital or analog communication links.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for scheduling transmission of remote and local data packets over a shared medium, the method comprising:
providing a scheduler;
generating virtual packets corresponding to the remote data packets;
scheduling the virtual data packets in the scheduler; and,
when the scheduler indicates that a remote packet should be transmitted over the shared medium assigning a transmission opportunity to the remote station.

2. A method according to claim 1 comprising scheduling both local packets and virtual packets in the scheduler.

3. A method according to claim 1 wherein generating the virtual packets comprises automatically generating the virtual packets based upon expected flow information specifying one or more of: an expected pattern of the remote packets; an average expected rate of the remote packets; a peak rate of the remote packets; a burst size for the remote packets; a maximum size for the remote packets; an average size for the remote packets; and, a service interval for the remote packets.

4. A method according to claim 3 comprising obtaining the expected flow information by exchanging messages with the remote station prior to generating the virtual packets.

5. A method according to claim 1 performed at a central station connected to a plurality of downstream stations by the shared medium.

6. A method according to claim 5 wherein the shared medium is a wireless medium.

7. A method according to claim 5 wherein the central station comprises an access point of a wireless network operating on an IEEE 802.11 protocol.

8. Networking apparatus comprising:
a packet scheduler;
a buffer containing local packets to be transmitted on the shared medium;
means for transmitting the local packets on the shared medium;
means for receiving packets transmitted on the shared medium by remote stations;
a virtual packet generator configured to generate virtual packets corresponding to packets expected to be transmitted by the remote stations;
wherein the scheduler is configured to schedule both the local packets and the virtual packets.

9. Networking apparatus according to claim 8 comprising a means for generating a transmission opportunity message (TXOP) wherein the scheduler is configured to trigger the means for generating a transmission opportunity message to generate a transmission opportunity message in response to a virtual packet bewing selected by the scheduler.

10. A method for centrally scheduling uplink and downlink packets in a central node of a multiple access network that uses a MAC layer, the method comprising:
generating virtual packets corresponding to the uplink packets;
scheduling the downlink packets and the virtual packets using a single scheduling discipline;
when a downlink packet is scheduled, transmitting the scheduled downlink packet; and,
when a virtual packet corresponding to an uplink packet located on a station is scheduled, assigning a transmission opportunity to the station on which the uplink packet corresponding to the scheduled virtual packet is located.

11. A method according to claim 10 wherein each virtual packet represents one uplink packet, and each virtual packet has a length equal to a length of the uplink packet represented by that virtual packet.

12. A method according to claim 10 wherein the network is configured for contention access operation and is capable of initiating one or more of contention free phases and controlled access phases.

13. A method according to claim 10 comprising adjusting the length of the virtual packets to account for extra polling in the MAC layer.

14. A method according to claim 10 comprising:
queuing packets belonging to sessions with reservations in controlled access queues;
queueing packets belonging to sessions without reservations in prioritized contention access queues;
serving the controlled access queues using an inner scheduler; and
using a remaining capacity of the central node to serve the prioritized contention access queues.

15. A method according to claim 14 wherein:
a number of controlled access queues depends on a number of sessions accepted and set up by the central node; and
a number of contention access queues is equal to a number of priority levels.

16. A method according to claim 14 comprising tagging each packet belonging to a downlink controlled access session with an eligibility time stamp specifying when that packet is eligible for controlled access service.

17. A method according to claim 14 comprising:
providing a scheduler controller for deciding when channel access is given to the inner scheduler for controlled access and when channel access given to a contention access mechanism for contention access, wherein the scheduler controller examines all controlled access queues and:
if any virtual packets or eligible downlink real packets are located, the inner scheduler is invoked to select a packet for service; and,
if no virtual packets or eligible downlink real packets are located, the scheduler controller gives channel access to the contention access mechanism.

18. A method according to claim 17 comprising allowing all regular contention queues plus downlink controlled access queues to participate in a prioritized contention procedure for accessing the channel.

19. A method according to claim 14 comprising:
compensating for lost controlled access service for uplink flows with resource reservation by:
maintaining a budget parameter for each uplink session with resource reservation;
for each virtual packet served, increasing the budget parameter by an amount determined by a size of that virtual packet;
for each received packet corresponding to the served virtual packet, reducing the budget parameter by an amount determined by a size of that received packet; and,
when the budget parameter is positive, compensating the corresponding uplink session by one of:
assigning the excess budget in the next virtual packet served for the same session; and,
generating a compensation virtual packet for the corresponding uplink session and queuing the compensation virtual packet at the end of the corresponding queue.

20. A method according to claim 19 wherein the compensation virtual packet is generated when an indication of non-zero queue size is received from the station, and wherein a size of the generated compensation virtual packet is the lower of a declared queue size received from the station and the maximum allowed packet size for the session.

21. A method according to claim 14 comprising, when a served packet is served, adjusting a time stamp of one or more remaining packets in the served packet's queue.
